(19) United States
(12) Patent Application Publication
(10) Pub. No.: US 2010/0270389 A1
(43) Pub. Date: Oct. 28, 2010

(54) Method of dangerous phenomena (mainly, hurricane) and global warning weakening

(76) Inventor: Boris Feldman, Thornhill (CA)

Correspondence Address: FELDMAN BORIS, 148 CARL TENNEN ST., THORNHILL, ON, L4J7B1, CA

(21) Appl. No.: 12/590,322

(22) Filed: Nov. 6, 2009

Related U.S. Application Data
(63) Continuation-in-part of application No. 12/386,847, filed on Apr. 24, 2009, now abandoned.

(51) Int. Cl. A01G 15/00

(52) U.S. Cl. 239/2.1; 239/14.1

(57) ABSTRACT

The method of gradual weakening of moving hurricane which prevents to gain in maximum energy and some means useful at protection against hurricanes and global warming weakening are offered.

### CROSS REFERENCE TO RELATED APPLICATIONS

This application is a continuation-in-part of application U.S. Ser. No. 12/386,847 (Feldman B.) entitled “Distributed system for preservation of natural vitally important environment conditions”, filed on 20 Apr. 2009, and “Relocatable water pump station for and method of dangerous natural phenomena (mainly hurricane) weakening”, US 20070270057, filed May 22, 2006, Feldman B., et al.

### TECHNICAL FIELD

The present invention relates to problem of the protection against dangerous natural phenomena (mainly, hurricane (typhoon), tornado etc.) and global warning.

### BACKGROUND OF THE INVENTION

Hurricanes cause great harm to the inhabitants of dangerous regions. They cause loss of life and destruction, suffer damage of billions tens billions of dollars. On the other hand, any unhappy impacts on hurricanes can be dangerous to humans and very dangerous legally. Even the weakening of the hurricane in that direction where the people wait a rain can cause serious problems. Using the tools and techniques proposed in this application is determined not only technical solutions but also the legal issues and the interests of countries, regions or cities. All below-listed tools and methods can be used both together and in any combination.

Many data suggest that global warming and hurricanes are related phenomena. Rising average temperature leads to increased hurricane activity. On the other hand, each hurricane discharges partially of the energy accumulated in the atmosphere due to warming. Therefore, the fight against hurricanes is divided into two areas: the fight against global warming, covering a significant area of the Earth (global), and specific methods of protection against hurricanes in certain geographical areas and predetermined times for weakening them (local).

(Global) There are many ways of global warming weakening. Passive methods include the reduction of heat and CO2 in the atmosphere. Active methods offer to burial of CO2, creating reflective coatings, various screens (to reduce the proportion of light energy reaching the earth's surface), cooling ocean surface, and others. Many of the proposals are interesting, but unlikely to be realized because of the huge cost and serious drawbacks: they are not reversible, for example, after the installation of screens or lenses in cosmos, which would require tens of years, humanity could face a problem that in the new climatic conditions, they are simply harmful. And there is no back way.

The most interesting global project based on analysis of the results of climatic changes during strong volcanic eruptions. Sulfur aerosols created a cloud darkening, which led to a marked decrease in the average temperature. Such aerosols gradually disperse and fall to earth as acid rain. Project idea came long ago, apparently, it was first made by E. Teller. Then she was in the work of M. Budyko (1974). At present, this idea is developed and promoted by W. Brocker, P. Crutzen and Ju. Israel (RU) that are revived this idea and offered a concrete technology for Earth protection from excessive solar heat.

By its estimations after dispersion in a stratosphere approximately 600 thousand tons (Ju. Israel) or 1 million tons (P. Crutzen) of special sulfur-inclusive aerosols that can be sprayed to stratosphere by usual jet planes (Ju. Israel) or by giant cannons or balloons. P. Crutzen estimates expenses as 50 billions of dollars and thinks that this project requires at least 10 years. Such cloud allows to decrease the average annual temperature can go down approximately on 1-2 degrees. Artificial formations are not adhered to the birth place and drift in a stratosphere, forming the Earth protecting screen. Such screen will hold on one and two years and can protect the Earth from solar warm. The advantage of this method consists in that this screen dissipates without constant additional charging. The lacks are a danger of acid rains and an unpredictable reaction of the various countries. Especially as dispersion of sulfate aerosols will cause the chain of reactions, as a result of which freed chlorine destroying an ozone layer, probably, thus, than less particle, the more effective aerosols and the more dangerous for an ozone layer.

Ju. Israel offered more cheap method, that aircrafts disperse sulfur aerosol in the air at an altitude of 10-11 km, using high fuel. However, the existing standards set allowable levels of sulfur in the fuel for subsonic jet aircraft epφe are not higher than 0.25% (RF). Assume that the engine consumes an average 3 tons of fuel per hour, the duration of the flight—4 hours, the average number of engines—3, the average loading of the aircraft—100 passengers. In 2006 in the world it is moved approximately 2, 13 billion passengers. This gives 21, 3 million flights and 21, 3*10E6*3*4*3 tons=767 million tons/year. Take 600 000 tons per years as the average of the values proposed by P. Crutzen (USA), and Ju. Israel (RF). Then the spraying of 600 thousand tons of sulfur will require changing the rules. It requires 0.08% additionally, i.e. one-third (assuming, of course, that all world's aircraft moved to a new fuel). Changing the rules associated with the guarantees of manufacturers of engines, which is sufficient longer and costly. In the last proposal Ju. Israel suggests to lower required necessary volume.

The author of pat. appl. Ser. No. 12/386,847 (Feldman B., 2009) offered to use: 1) inflatable structures, having through channel, through which the ascending air flow is able to raise the required amount of sulfur aerosol to the desired height, 2) the fixed positions of such structures that will allow to explore the influence of the parameters of small particle—size, flow, etc., 3) the small pieces of ice (or snowflakes), particles or other similar reagents, instead of sulfur, which can destroy the ozone layer.

The followed in some months the publication Quine et. al. (A free-standing space structure, Acta Astronautica, 65 (2009), 365-375 about the multikilometer inflatable tower for space elevator creation project, and project of 15 km tower stressed the strong interest in similar structures, which were previously at the level of semi-fantastic projects (Pokrovsky G., Inflatable tower 150 km in height, 1956—in Russian; Bolonkin A., Optimal Inflatable Space Towers with 3-100 km Height, World Space Congress 2002). This work presented the first real design of tower of many kilometer in height on the basis of independent gyro stabilization of each vertical section. The work of Quine et. Al. and their experiments have created important base for creation of inflatable towers of practically any height.

On the other hand, use of said jet streams for struggle against warming is enough problematic. As “jets” close only a strip of the ground, and the areas that are located under said strip will appear blacked more out, and their temperature will go down. Many similar areas lying under jets are connected with agriculture, the extremely sensitive to changes of average temperature even on one degree. Therefore a lot of the countries cannot agree that the similar screen was placed on them.

A number of patents using the technique for cloud creation and destruction as like to weather control. Chine Patent CN 1335054 (Bai Ying, 2002) proposed to use that the saturated vapor pressure lowers with the reducing air temperature and that the temperature and pressure of air in high altitude in relatively lower, air in lower altitude is conveyed by using a vertical pipe to high altitude and is cooled to separate large amount of condensate water to form cloud. Such system can obscure a small area, its productivity is low. The application WO2008/1475235 (Tarasov A F et al.) offer to spray water from the airplanes flying to create a cloud of icy particles, forming a shadow on the Earth's surface. This system allows you to create the necessary local cloud, but its dimensions are determined by the number of sorties, the corresponding fuel consumption and require almost daily maintenance, which significantly limits the possibility of its application.

Recent researches (Geophysical Research Letters) in the Southern Ocean showed that the decline in the concentration of ozone in the stratosphere causes an increase in radiation levels because of ozone deficit and changes the atmospheric circulation in the southern polar regions, increasing winds. This causes a rise to the surface deep water layers, saturated with CO2 and unable to absorb more CO2. The saturation of CO2 leads to excessive increase of the water acidity. This upsets the chemical balance and makes it difficult the CO2 absorption and burying CO2 by natural absorbers (corals and mollusks). Therefore, the protection of the ozone layer and its restoration (Feldman B., RU2088073, 1992) may be an important factor in the struggle against global warming and hurricanes.

Researchers Colin Price (Israel) and his colleagues traced the chronology of the birth, development and extinction of tropical cyclones that brought severe storms in 2005-2007. They found that approximately one day prior to the development of a storm into a hurricane with a wind force of more than 320 kilometers, and the frequency of lightning in approaching air front reaches its maximum. Lightning discharges initiate wind vortex formation in monsoons, and these whirlwinds often are germs of hurricanes. Therefore, the weakening and/or regulation of electrical activity may allow to weaken the nascent storm. It is known that fuel-air-explosive (FAE) in thunderclouds, the impact of high-power pulsed laser radiation in a range of transparency of atmosphere and the bombing of a cloud with hundreds of small pulsed microwave generators, using the power of the explosive, allow to weaken the electrical activity. These three processes contribute to discharge the “capacitors” inside said thunderstorm cloud and not allow them to accumulate high potential. A number of recent works demonstrate the significant role of electricity in growth of hurricanes and tornadoes. Impact upon tornadoes by FAE rockets, allowing to violate both the mechanical dynamics of the vortex, and the electrical field, suggested in US Pat. Appl. 20020088364 (Feldman B.).

Patent WO 2008/094226 (Leonov A. L. et al) proposed to use the supersonic shock wave, created by supersonic jet airplanes by flying around hurricane eye, for said hurricane suppression.

Amito Evan et al. shown that even the specific dust or sand storms can weaken a hurricane formed in the Atlantic Ocean. This dust shields Ocean and weakens the heating of the sea surface and thus reduces the energy of a hurricane. On the other hand, E. Shirkov (Rus.) found on the base of hurricane Gonu such time moment when the amount of water vapor carried by this hurricane has decreased dramatically and literally during one day of the hurricane gained tremendous force. The process of transforming water vapor into water in the hurricane goes constantly, but, when this process gathered momentum rapidly and the vapor concentration has fallen sharply, in the hurricane was thrown a huge amount of energy and just a night he scored a monstrous destructive force and the wind speed increased from 25 to 72 meters per second. One would expect that an attack by several FAE rockets, proposed by the author (US Pat. Appl. 20020088364), combined with other influences, and performed in the middle of the night could not only lead to the destabilization of certain areas of the hurricane, but the evaporation of this water, which is connected part of the energy of the hurricane.

The increase dust cloud weakens a hurricane (A T Evan, J. Foley, D. Rosenfeld . In the application to (WIPO 2008/092226, Rosenfeld D. et al.) shown in the model that introducted smoke into the lower parts of a hurricane causes water vapor to condense at a lower altitude than usual, and form droplets that are too small to fall as rain. Instead, they are carried away in the upper, more peripheral area of the storm, and eventually reach the place where they freeze. This provides a spread of energy at the edges of the storm, which would destabilize its center and lowers the wind speed. These authors estimated that the required number of aerosol corresponds to 200 tons per hour and some of these servings should be 5-10. However, a number of application requirements are difficult to do in practice, for example, “the CCN have a diameter less than 1 micron”.

Researches of S. Twomey confirmed that the dispersion in the turbulent layer under the clouds of tiny droplets of water will allow the clouds to better reflect the sunlight. For realization of these researches Stephen Salter (England) suggested to start in ocean a plurality of yachts for dispersion shallow drops of water in clouds to stop the Global Warmer. For motion said yachts, having revolved vertical Fletcher cylinders, will produce energy, supplying the systems of remote management and turbine for the troop landing of water in an atmosphere. On his calculations, drops waters, nebulized in sky, must promote the whiteness of clouds, that will allow to reflect some part of the sun world, and about million yachts with the nebulizers of water will be capable to compensate the average annual emission of CO2. These digits “million yachts” are doing quite unrealistic this project, as each yacht Salter will cost at least $ 100,000 US (enough to compare with the price of cars).

In the following years, a theoretical study Alamaro M., Michele J., Pudov V. “A preliminary Assessment of Inducing Anthropogenic Tropical Cyclones Using Compressible Free Jets and the Potential for Hurricane Mitigation”, Journal of Weather modification v. 38, 2005, p. 82-96. These authors demonstrated that ascending hot air flow that is created by the group of twenty vertical oriented jets is able to prevent a hurricane progress. This result was obtained on the base of a mathematical model and parameters of known hurricane. And though estimations give not so high efficiency (10%), use of such method can be useful if to provide delivery of the equipment in the necessary place during necessary time

However, they don't offer any technical solution. Placement of the engines on the barge is un successful. For struggle against hurricane it is necessary that these generators would be in the right place at the right time. However, the total weight of the required apparatus includes: 1) weight 20 engines for 3900 lb*20=78 000 lb=34.7 tons, 2) weight of the necessary fuel for these engines: TF33P3 for 12 hours at TSFC=(0.52 lb/(lbf*h) and Thust=17 000 lb, is, respectively, 0.52*17000*12*20=2,550,000 lb=1,130 tons, 3) weight of the massive platform on which are mounted engines (35 tons) of not less than 300 tons, since the total thrust of these engine is equal to 17 000 lb*20=340,000 lb=151 tons, dobavztn 4) weight of equipment—100 tons (estimated). As a result a need to quickly move not less than 34,7+1,130+100+300=1,565 tons, including: equipment and fuel, 435 tons 1,130 tons. These figures do not include the weight of the barge.

There is now no means of delivery, satisfying these requirements. The most suitable for this is ekranoplanes. But ekranoplan Pelican Ultra Large Transport Aircraft (ULTRA) ground-based appears about 2015. Average model has a capacity that is equal to 1400 tons (at the distance of 16 000 km) and the speed to 490 km/hour. This is enough for an emergency delivery, but the <<ground-based>> option complicates it using. Project hybrid airship (Walrus etc) can be useful. The aircrafts An-225-100 (220-250 tons, 450 km/hour, 11000 m) may be also used. The delivery means for to closer distances can be used such aircrafts as C-17A (MacDonnell-Douglas, 78 tons), An-225 Cossack heavy freighter aircraft (155 tons), as well as the high-speed water vessels with a dynamic principle of maintenance, as like (Hudrofoil (SPC) and Cushioncraft (SVP). U.S. National hurricane center should report on the expected hurricane for 36 hours before his appearance on the coast. Apparently, the hours of 6 are needed to clarify its effect and the expected trajectory. About 12 hours is required for the operation of the vertical flows, 3-4 hours should be spent on the preparation of the generators and remains the order of 36−12−6−4=14 hours to move the system of generators in the right point. Possible points may lie at a distance of 4.6 thousand km from the place-based delivery vehicles. Moreover, during these 14 hours of the hurricane may slightly change the trajectory, it will need correct its trajectory of delivery and to extend the desired path. Therefore, the required speed of delivery shall not be less than 6 thousand km/14 hours=430 km/hour. At present there is no means of moving such barge with such speed that distance.

E. Emanuel and M. Alamaro offered to use a thin oil (or oily substance) layer (monolayer) that has to reduce water evaporation and is stable at wind speeds up to 25 mph. However, within the hurricane (except “eye”) the waves are sufficiently strong, and they can destroy this film. It is known that the oil film, which is cast from the bow of the ship, just behind the stem is broken and the excitement increases sharply. On older ships on the nose was fixed oiled rope brush. The large size of the hurricane and the need to add oil will lead to severe environmental consequences, when this oil will reach the shore a few days later.

The little-known study of E. Chernjuk (Technika Molodezhi—in Russian, #1, 1979) seems very interesting. The author notes that the high evaporation leads to increased salinity and hence the density of remaining water. The mass of heavy water fall down as a funnel, forming a downward vortex. With the lowering of the central jet is cooled (the Rank's effect), its density and speed increase and form the cavitation bubbles at shallow depths. The author conducted several laboratory experiments, which somehow confirmed this picture. It seems reasonable to assume that the submarines and surface of the hurricane strongly linked with each other and are part of a single phenomenon.

The next methods are related to cooling of the sea surface. Similar ideas were expressed earlier (Dann et al., Kirke B.) Different variants of devices for pumping up deeper cooler water to an ocean surface with the help of water pumps using wave energy are proposed (US Pat. Appl. 20070270057 by Feldman B. offered to produce a vertical pipe for upwelling of a flexible material that can be deliver rapidly, US Pat. Appl. 20080175728 by Kithil P. W. etc). There are proposals that are proposed to create a vast field of such stations for pre-cooling the great ocean surface. This is dangerous, because this cooling will lead to a gradual lowering the layer of cold water and reducing its role as natural refrigerator. Further it will be necessary to pump more and more. Secondly, the lifting deep water, richer in CO2, but have not yet transformed to insoluble carbonates, leads in the allocation of CO2 and reduces its dissolubility (it decreases with decreasing pressure and increasing temperature). Therefore, such process makes sense to cool only a limited area, but it demands mobile devices and faster means for their delivery.

The wave-pump sprayers (US Pat. Appl. 200702700571), accelerating preliminary evaporation, can be used for cooling the sea surface. They are simpler, easily transported, and the length of their pipe is not connected with cold water depth.

Recently published: US Pat. Appl. 20090173386, 20090173404, 20090173801, 20090175685 and 20090177569 (Bowers J A et al., Gates W. H.), comprising three main proposals: a) an original method to assess of the risks arising during the protection against hurricanes,
b) cooling the sea surface by moving warm surface water to deep water layers that causes a rise of colder deep water in sea surface place with the help of many vessels,
c) a system of a whole Gulf of Mexico and Caribbean sea protection against hurricane on the base of a plurality of advanced downwelling vessels.

The placement of a dense network of plants could interfere break navigation of other vessels, because of for significant change of temperature condition of a large water area requires to have many stations. The using of warm surface water downwelling for cooling the ocean surface includes two-step process: at first—warm water is pumped into the depths, and there it supersedes cold water upward. This process can be effective only by a dense network of stations. Similarly, the using of large tanks filled with water requires a plurality of said tanks to obtain an adequate effect. Besides in these works the huge stream of light-weight fresh warm water of Mississippi is not considered

Furthermore, said Pat. Appl. 20090173386 (and other) emphasizes that the proposed system can enhance the absorption of CO2 surface layer of the ocean and contribute to its immersion and absorption by phytoplankton. However, increased absorption of CO2 leads to a very dangerous rise in ocean acidity, and an absorption falls. It is important, as it has been specified in the application RU 93011572 (B. Feldman, 1993) that CO2 has been absorbed by natural dioxide absorbers (corals, molluscs, saprae), which are capable to tranform CO2 in the form of insoluble substances (limy skeletons, waste), and it is useful to intensify this process under the control (U.S. pat. appl. Ser. No. 12/386,847, Feldman B.), not supposing increase of ocean acidity.

In addition, these processes are 1) too difficult, expensive, it is dangerous to wait when a hurricane will reach maximum energy, 2) a number of claims, as proposed in these patents are not explained or justified, in particular: “hurricane deflection”, “hurricane prevention”, “atmospheric modification”, “weather modification”, “climate modification” (US20090173386, cl. 32, 34-38), etc.

Method of Weather modification using an artificial upwelling was offered in U.S. Pat. No. 4,470,544 (Bronicki L. Y. et al) and U.S. Pat. No. 5,492,274 (Assaf G. et al.).

There is no offer allowing to protect a mouth of the river similar to Mississippi mouth against hurricane.

The set of projects offer to deliver icebergs to hurricane areas, but their massiveness complicates delivery during necessary time in the necessary place.

The above-mentioned projects can not to solve a problem of protection against hurricanes. Separate projects can weaken hurricane only partially. Hurricanes are very complex phenomena and require a multi-layered security.

A number of works (Karelskij V. G. et al., Arteha S. N.) called attention to the important role of electro-magnetic processes in tornado development and given the first estimations.

The paper of V. Pudov (Possible ways to Mitigate the Devastating Impact of Hurricane (Typhoons), Issues of Risk Analysis, v. 5, 2008, No. 1 in Russian, abst.—in Eng.) is, visible, the most serious work from last works wherein it is discussed problems of struggle against hurricanes. The author tells about the researches lead to Russia and shows, that a role of electromagnetic forces is essential enough; their density can even exceed density of all other forces operating in hurricane. For very small drops electric forces exceed gravity, and masses of fine drops rises upwards in clouds, transferring there the electric charge that helps unwinding air masses. Therefore reducing of electrical field intensity of hurricane cloudy structure could promote decrease of its activity. Besides the author informed that creation of powerful hot air streams allows to weaken only on 10% the enthalpy of ocean surface layer, while a role of upwelling about 55%.

Thus it is necessary to note huge complexity and discrepancy of this problem. Destruction of hurricanes that are means of natural discharge natural processes can lead to unpredictable consequences. Creation of darkening screens by means of subtropical jets not only will lower temperature on the ground a little, but will lead to cooling of the areas laying directly under these jets. It is terrible for the agricultural areas. And never the corresponding countries will give their consent to destruction agricultural manufacture and deprivation of work and livelihood big quantity of people.

### SUMMARY

The first aspect of the present invention consists in that in creation of the method, combining of global and local means for struggle against hurricanes and warming that allows to achieve total huge effect, importantly, to prevent hurricane gained the huge rotating speed (and energy). Each separate influence can be insignificant and correspond to opportunities of people, but their joint action allows to receive essential effect that does possible their use.

The second aspect of the present invention consists in that all used means are reversible and do not create irreversible effects. At least, the part of the offered means allows to estimate their influence on the nature and to use these estimations. Separate components of the offered methods and means can be used, as separately, so in any combination. It is defined as technical, economic and legal opportunities, and possible influence separate a component on other processes, similarly to <<arctic fluctuation>>.

The third aspect consists in that for the decision of a considered problems the cheapest decisions are chosen or developed, accessible at a modern level of techniques and so that gradual influences to weaken and/or to decline dangerous hurricane, and also a number of the means providing use uniform multistep method that will allow to begin the use at least a part of offered decisions in the near future.

Said decisions are divide conditionally into three sections:
global the covering greater regions, promoting reduction of hurricane activity and that have been not connected with concrete hurricane,
local that are connected with struggle against concrete hurricane,
coastal relating to the protect of dangerous coast.

The sixth aspect consists in creating continuous ascending flows of particles used for said screen creation, allowing to create darkening screens.

The following aspect consists in creating a plurality of towers having through channel through which by ejection of a stream of small particles to a corresponding wind level to creation a screen which is darkening areas laying under it.

The main aspect consists in using through channel for constant lifting of “particles” to the height of wind flow and for creating darkening screens.

The following aspect consists in use for temperature decreasing both different wind streams, and screening from solar heat of water current surfaces moving into dangerous region.

The tenth aspect consists in use for said screen creation said small particles are chosen from followings: not only sulfur oxide, but also drops, smallest ice particles, snow flakes, small unmanned soaring gliders or aircrafts from thin plastic, small reflecting inflated balloons, soap bubbles, particles transforming sun light UF to visible or IR range, including above-mentioned but not limited.

The following aspect consists in that these balloons and bubbles should be filled with light-weight gas (including: natural gas, hydrogen, air, helium, their different mixes, but not limited). The filler is chosen depending on price, penetrating ability, a role of methane as greenhouse gas etc.

The second main aspect consists in using “particles”, chosen from followings:
long-living particles for creating darkening screen over such areas that are connected with legal problems or don't their requirements,
long-living objects that are characterized in that a most part of them is capable to be to remain in the air flow and to change their darkening properties under external actions but so that they can restore these properties at any time after,
short-living particles the lifetime of which must be ended before such areas where they can break said requirements. And said short lifetime can be secured by their parameters or external actions,
transforming warming particles that are capable to transform UV into IR and/or visible spectrum range, are located at height of ozone layer or over and are used for compensation of cooling of Earth surface areas, and/or
their combinations.

The third main aspect consists in that types of said particles are chosen from following: aerosol, small water drops, small ice particles, snowflakes, small unmanned soaring gliders or aircrafts from thin reflecting plastic, small reflecting inflated balloons, particles transforming sun light UF to visible or IR range, soap bubbles, and their combinations, including but not limited. The pump located on the ground creates ascending air flow that lifts said particles. Besides, said small reflecting inflated balloons and soap bubbles can lift using pressure difference that wind flow induces near top outlet or its lifting force. It is possible that these can lift from ground surface directly. The improved plasticity of frozen soap bubbles allows waiting that they can be used to advantage in darkening screens.

The following aspect consists in use of long-living particles and short-living particles so that the first can be in air long, more than one day, the others exist or keep their shading (or reflecting) properties only during flight above the predetermined region limited by requirements of ground temperature or legal agreements. And said particles of the second group can lose said properties both as a result of internal transformation, and under influence beam (the laser or microwaves) from the ground. These method allows to create regional screens, and said regional screens are capable to shield the limited territory (for example, on dangerous water area of ocean) against solar heat and to use both jet, and other wind streams, including but not limiting: trade wind, and also passing sea currents.

The yet aspect consists in that use of the wind currents located at different height (jet currents, trade winds and others) allows to organize the is global-regional blackout, allowing to consider and even to bypass sites agricultural areas, sensitive to temperature, and even at least partially to compensate cooling by use of particles, transforming UV in IR and/or visible spectral range. As a jet covering non-uniformly then combining their arrangements of said structures, their heights and density of a particle stream it is possible to chosen a degree of darkening of separate areas and even will allow to satisfy requirements of agricultural holdings, the extremely sensitive to temperature. Therefore the opportunity of creation of regional darkening is very important. At the same time transformation UV will allow to improve temperature conditions of the separate territories making agriculture production, simultaneously protecting from UV.

In other aspect, a method includes crediting “anti-smog”, at least in North Polar zone, that is a plurality of flows of long-living particles that have very reflecting surface (ice particles etc.) generated in the polar region and more south region, and so that these particles move in the Arctic ocean, and also includes creating a darkening screen in South Polar Jet to slow down warming these natural “refrigerators”.

The other aspect consists in that said structures have the constant (or their controllable moving) positions, and it enables to operate size of a stream, the sizes of particles, their color and their material that allows to realize constant monitoring of their action and to define and realize the optimal mode, including result of joint action of streams that are located at different heights by different said structure arrangement, to estimate results of their influence to atmospheric and ground processes, allows to predict results and to avoid harmful consequences.

The other aspect consists in that the said proposals allow to lower temperatures of Atlantic and can result additionally to weaken droughts and to reduce soil erosion of the western USA plains.

The other aspect consists in that tower that can be made in the form of followings, including but not limiting: inflated tower having embedded gyro stabilization, placed at the same distance, inflated tower, solid tower or lattice tower,
combined structure including said inflated and solid tower, that can be used for ascending flow creating and said tower comprises one or more through channels.

The following aspect consists in that at least a part of said towers can include located at the height wind electric generators as having a vertical axis, as having a horizontal axis. And such “electrical forest” requires less areas, than any other device.

The other aspect consists in that simple, cheap and technological floating design using only an alternative energy of wind and waves for forming of small drops of sea water, ejecting said drops and creation of an additional reflecting bleaching layer under clouds is offered. And it is offered to use the printer piezoheads for fine water drops forming.

The above-mentioned aspects describe actions independent of concrete hurricane. The following aspects are connected with each concrete hurricane weakening, they also include the control that accompanies each hurricane from the moment of its occurrence, including measurement of main parameters (quantity of water vapors, rotation speed), and also water surface temperature in dangerous region, distribution of a wind speed with height. On the basis of these data it is possible to made the forecast of the further development and the moments and places of following influences in view of real opportunities and is defined by the account of legal problems.

The other aspect consists in carrying out constant monitoring of electrical activity (frequencies of lightning and intensity of an electric field) in areas where hurricanes start to be formed. When said values exceed a limit to use the means weakening lighting activity that include but not limited: launching FAE rockets, VHF generator clouds, EM pulses, laser ionized channels and powerful electromagnetic impulses.

The following aspect consists in that approximately day-after action indicated in previous aspect it is sowed the thin dust particles to the hurricane area, wherein the maximum quality of water vapors.

The following aspect consists in that when the quality of water vapors exceed the predetermined level then it is sowed the followings chosen from: thin dust, silver iodine, gel, to the area, wherein the maximum quality of water vapors.

The other aspect consists in that at the same time it is carried out:
launching a FAE rocket steam to the hurricane eye wall to destroy vertical structure to enable a pressure difference to break through this wall and weakening of electric field intensity,
airdropping a network having EH generators in its knots, and further submerging this network, straightening up opposite the lower (underwater) part of hurricane, and creating the stock wave (by exploding spark gap (water gap or metallic band or wire) for destroying underwater structure of hurricane,
creating supersonic shock waves by supersonic jet airplanes, and
   all these actions must be executed coordinately.

The following aspect consists in that the advanced scheme of FAE rockets, suitable in conditions of the strong wind, is offered, and this scheme allows to generate a mix of the necessary concentration in the protected conditions.

The following aspect consists in that said method, wherein the stationary positions of said towers allow to research color, sizes, material of said particles, the effects of said flows and their parameters on environment.

The following aspect consists in that in case of insufficiency of said previous actions new barriers are created on the hurricane way, and these barriers consist of ascending hot air flows and/or ascending deep cold water flows. Said barriers are located across the hurricane way or at an angle to this way so that to promote to hurricane deviation in the necessary party.

The following aspect consists in that it is proposed the set of easily transported modules allowing:
to deliver operatively generators of hot air (aviation jets) and necessary fuel to a predetermined place,
to collect automatically said modules, that are capable independently to float, in the predetermined order,
to moor said modules to each other and to unite the built in distributed fuel systems,
to form the floating platform, on which said engines are mounted,
to create a set of hot air ascending flows.

The following aspect consists in using said water pump stations comprising extended downwards bendable conduit, allowing operative to deliver said stations in folded state by air crafts and airdropping them to predetermined place,and these stations are capable independently to transform into working state and to start lifting deep cold water.

The following aspect consists in that the dangerous coastal water area is protected:
by cooling a surface by deep cold water,
by lowering warm surface into depth,
by clearing water surface by special skimmers in the case if it is necessary,
by using thawing ice arrays that are delivered by means of special tankers, the ships from an ice or icebergs.

The following aspect consists in that the design of floating skimmers using wave energy is offered.

The following aspect consists in that means cooling river water are placed in the river mouth and the lower watercourse of river, and these means are chosen from followings: reserves of ice kept at the river bottom or river coast in heat-shielding easily dumped envelops, ships loaded by an ice, icebergs, and said means can be anchored or are grounded.

The other aspect consists in that time and places, where ice files or icebergs are especially necessary (mouths of the rivers similar Mississippi or dangerous coast) and ways of them delivery, suitable for these places.

The last but one aspect consists in that these applications use a set of new proposals that are not tested practically and therefore the proposed scheme can be corrected by testing.

The last aspect consists in that:
many stages said in offered method are results of separate researches or of modeling, their importance for hurricane weakening can be insignificant individually, however, the given expanded method offers ways of their real application and an estimation of their real efficiency and offers ways of their testing to real conditions,
a lot of present offers is not connected with risk problems and can be realized in the near future, in particular: protecting polar zones, protecting the river mouth, clearing of sea surface, cooling of surface of Atlantic dangerous zone etc.
   Notice: Further all the means intended for their ejection, natural using lifting force or forced with pump action or pressure difference, will be named “particles”.

### BRIEF DESCRIPTION OF THE DRAWING

FIG. 1 shows common scheme of the proposed improved method

FIG. 2A represents General configuration of the Polar and Subtropical jet streams

FIG. 2B represents Trade wind.

FIG. 2C shows the Atlantic ocean water current (Subtropical gyres).

FIG. 2D represents a region of likely hurricane tracks.

FIG. 2E represents areas of location of two groups of the towers in Atlantic region.

FIG. 3 shows a space diagram of the proposed improved method.

FIG. 4 shows a set of embodiments of said towers having one or more through channels.

FIG. 5 shows the possibilities of using said towers as a base for wind electro generators mounting.

FIG. 6 shows a boat for creation of a drop flow for darkening clouds.

FIG. 7 shows a improved FAE rocket.

FIG. 8 shows a hurricane submerged part destroying (according to E. Chernjuk).

FIG. 9 shows means for creation of ascending flows of hot air and cold water.

FIG. 10 shows a set of means for cooling of the surface layer of sea water of Mexico Gulf.

FIG. 11 illustrates a method of water cleaning with help of a skimmer device.

FIG. 12 shows a method of fast airdropping on the base of special dirigible-hybrid having several little compensating jets.

FIG. 13. A flood protective height-adjustable barrier.

FIG. 14 shows an action of the shock wave generated by EHG on tsunami wave.

### DETAILED DESCRIPTION OF THE INVENTION

The offered improved method of hurricane and warming weakening is based on:
observations, which show that in process of warming hurricane activity increases,
hurricane's energy, especially on ended stage is so great, that it is possible to try only a hurricane to reject or weaken a little,
during formation of hurricanes their energy essentially less also it is possible to influence to them, trying them to weaken or reject,
utter annihilation of hurricanes exceed forces of people and is harmful, since hurricane is natural discharge of the energy which has been saved up in atmosphere and ocean,
necessity of special protection of coastal territories, especially big river mouth areas.
   These reasons concern also to other phenomena of similar type (a tornado, storm etc).

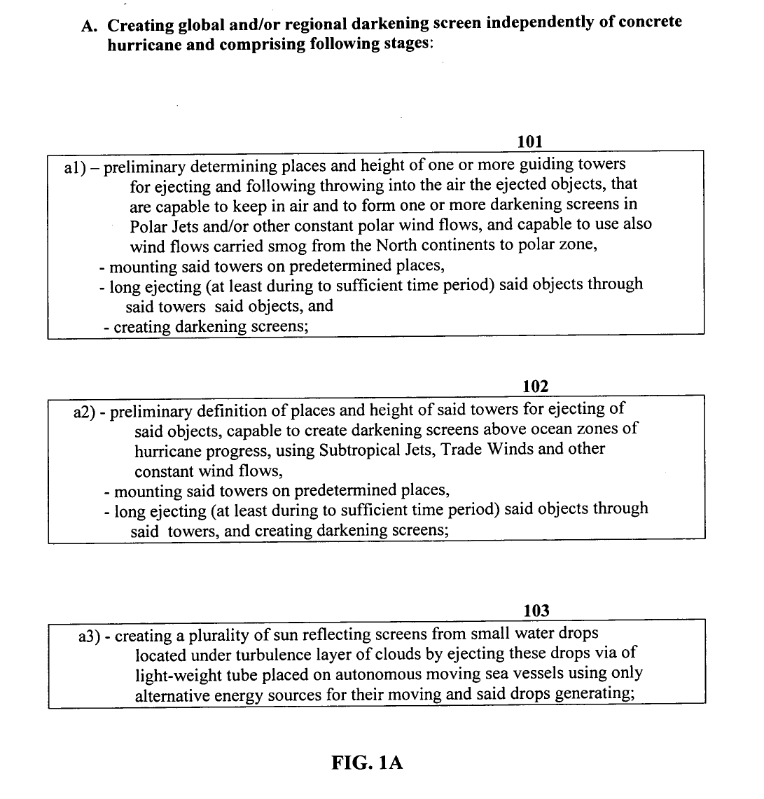

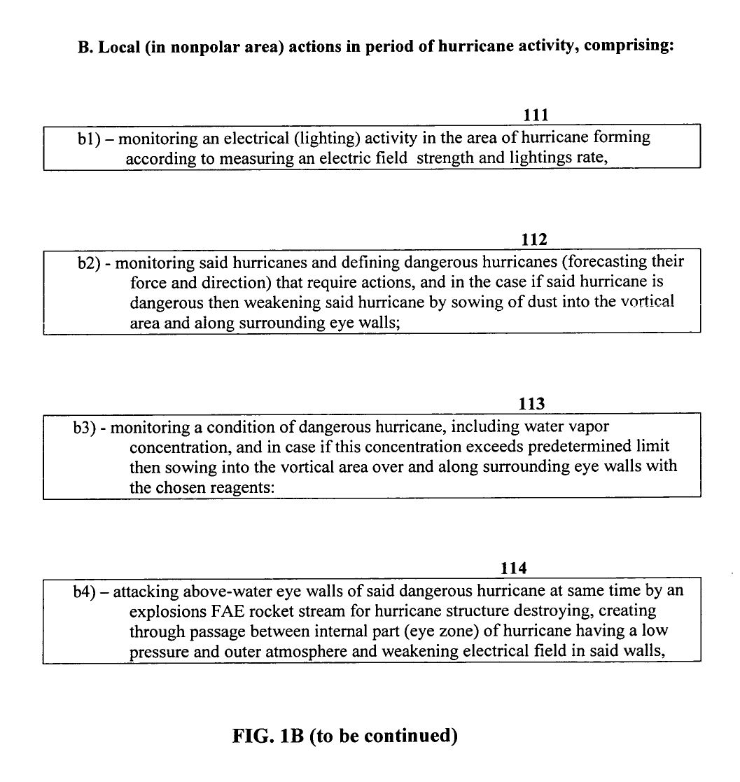

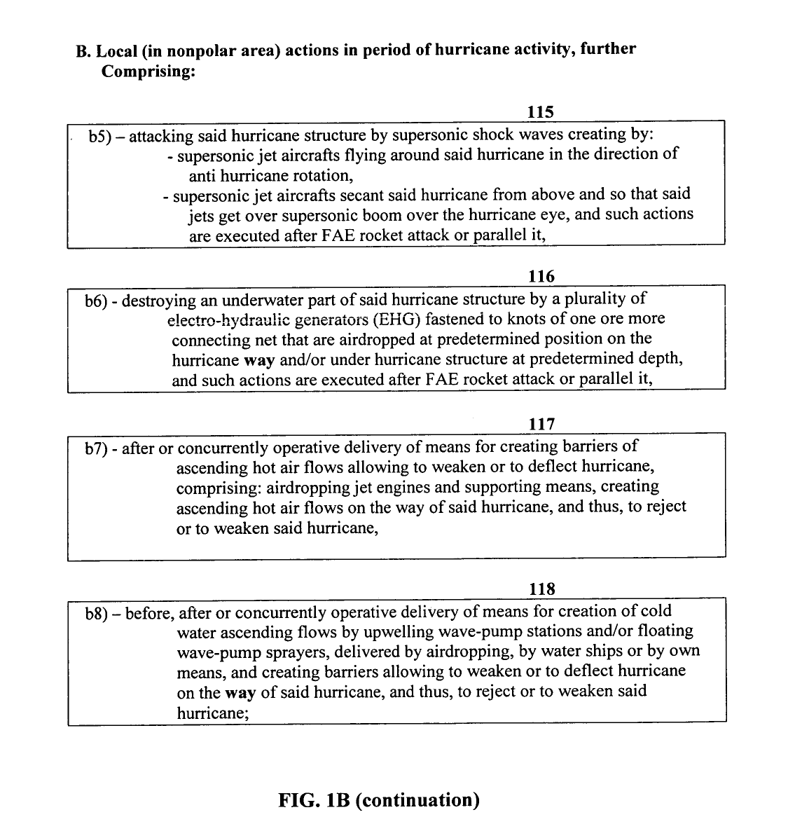

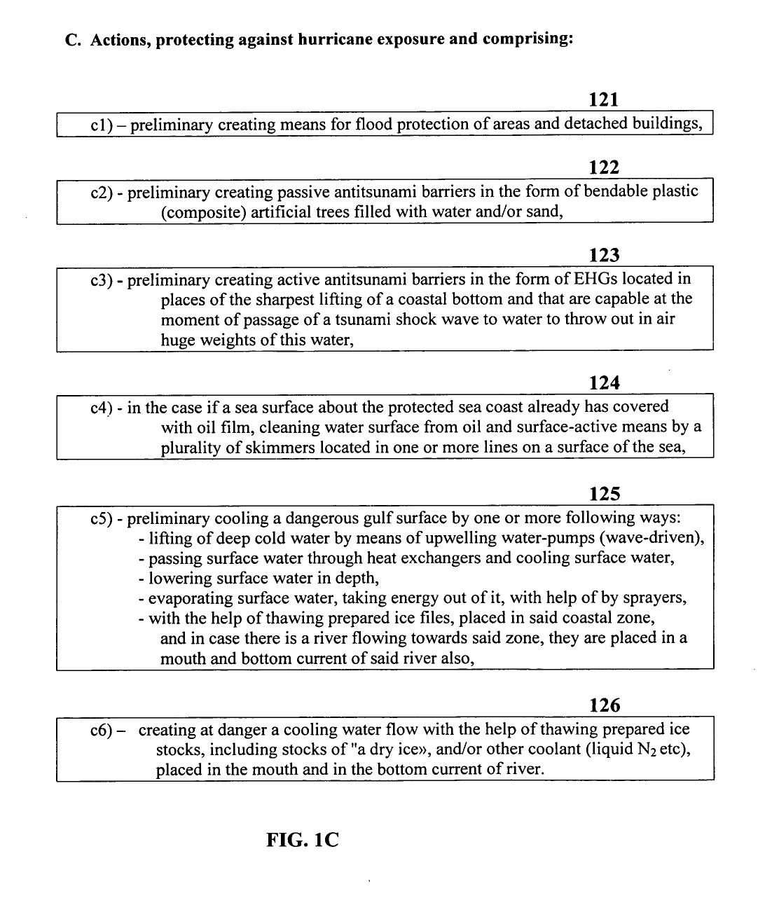

FIG. 1 represents common scheme of the present method. This method comprises three parts:
Global part, comprising procedures of said method that are independent of concrete hurricane (FIG. 1A),
Local part, comprising procedures of said method that are used for weakening of such hurricane that is recognized as dangerous and that are carried out by constant monitoring its conditions (FIG. 1B),
Coastal part, comprising procedures of said method connected with protection of coast, buildings and the people located on coast and in a mouth of the river (FIG. 1C).

A feature of this method consists in that all said procedures, promoting the decision of the said problems, are practically independent and can be used separately or in any combinations, since:
1) practically all the used decisions either have passed only modeling, or are physically proved, but have not been tested in real conditions practically, as and other methods specified in Background,
2) using these procedures depends on technical and economic opportunities, also from legal conditions.

Global part comprises three stages of offered method. The first and second stages 101 and 102 of Global part include creation of screens in atmosphere, darkening sunlight, the screens consisting from objects, which are ejected to atmosphere through channels of high towers and/or due to lifting force, and various atmosphere wind flows distribute them further. The first stage 101 of Global part is intended for creation of such screens in Polar zones. It can be used Polar Jet, winds of a cyclone, various wind flows, in particular those flows that bring “smog” to Arctic regions, including above-listed but not limiting. The basic goal of the first stage consists in weakening warming polar zones that are planetary refrigerators. These objects used for creation of screens in polar areas can be long-living and should not create dark traces on the ground or ice arrays in case of their falling. The problem of Arctic regions is defined by that:

polar zones are natural refrigerators of a planet and falling of their average temperatures is directly connected with warming,

for last 20 years growth of temperature in the Arctic zone occurred twice more quickly, than on a planet as a whole,

such screens do not close any agricultural areas and any rendered habitable areas, and their use cannot cause serious legal problems, and

if it will be possible to reach serious effect, it will affect not only warming, but also on storm activity, and also will allow reducing desalination of the Labrador current.

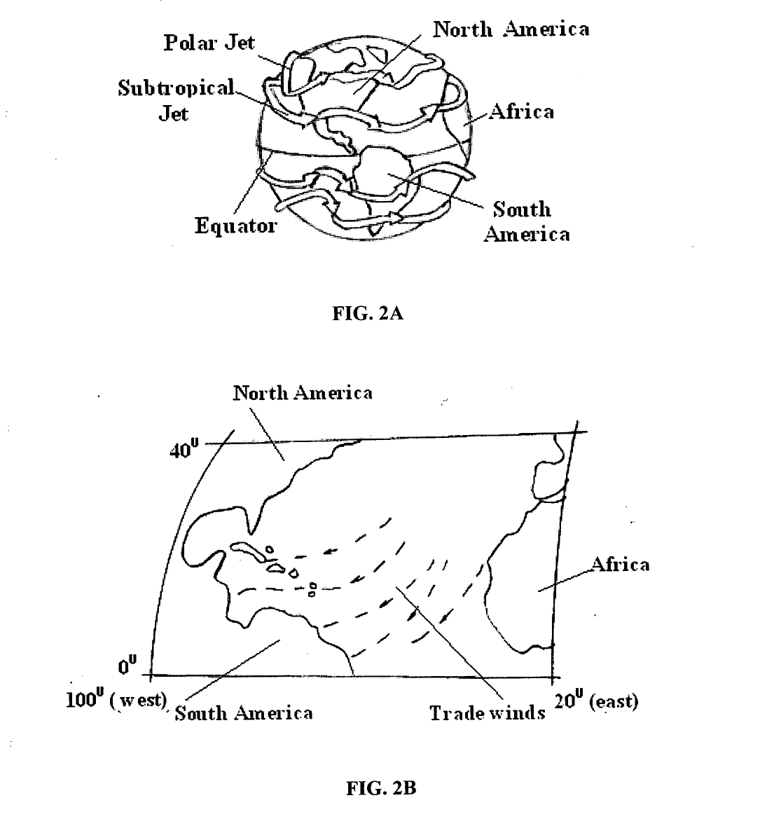

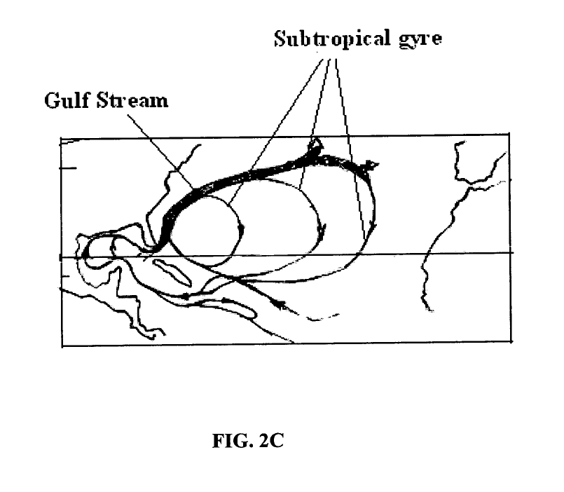

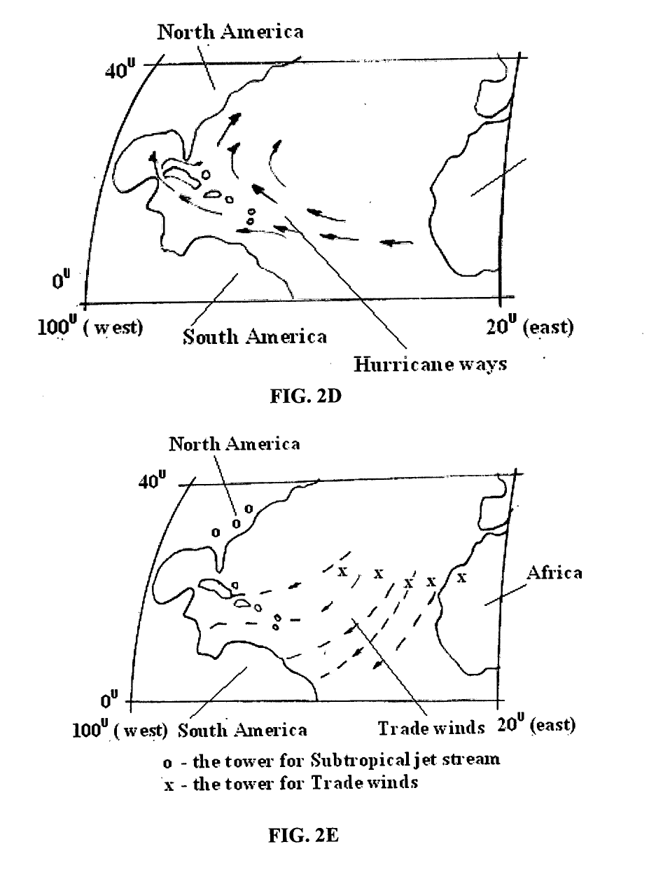

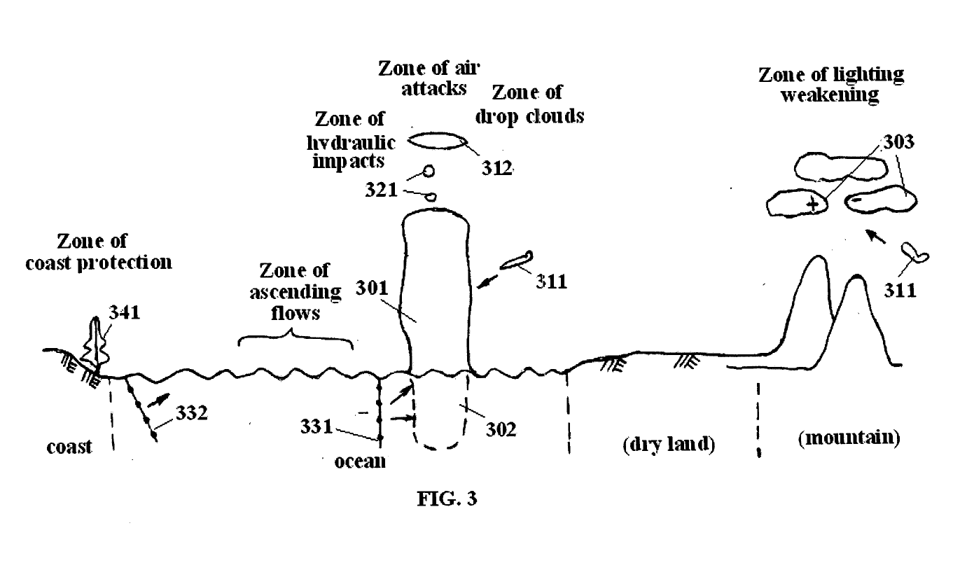

The second stage of Global part uses Subtropical Jet, Trade wind etc, including these flows, but not limited. FIG. 2A
(according to http://en.wikipedia.org/wiki/Jet_stream) shows Polar Jet and Subtropical Jet. Subtropical Jet flows over the Atlantic Ocean. FIG. 2B (according to
http://ru.wikipedia.org/wiki/%D0%A4%D0%B0%D0%B9%D0%BB:Earth_{—Global}_Circulation.jpg) shows Trade winds (summer.) This stage includes the creation of one or more screens that are capable to darken this subtropical zone. These screens must comprise said ejecting objects. These screens can cover partially the dangerous zone of hurricane development and promote downturn ocean surface temperature in this zone. Besides it is possible to reduce the quantity of heat that comes to dangerous region cooling water surface of Subtropical gyres additionally with the help of similar screen. FIG. 2C shows Subtropical gyres that returns from Gulf Stream in area of lower latitudes. FIG. 2D shows a zone of likely Atlantic hurricane tracks, and this zone is named as dangerous zone or dangerous region.

An important feature of this dangerous zone is that it is surrounded by the different countries, and their governments can disagree with change of a temperature mode of the countries or to put impracticable (unreal) conditions. Therefore it is necessary to create regional screening in the limited zone. For this purpose short-living ejecting objects are necessary. Time of their life should be limited to flight over the dangerous zone. Their screening properties should sharp decrease or absolutely disappear on borders of the dangerous zone, in particular, the dangerous zone of Atlantic ocean. The same the problem arises at wider use Subtropical Jet. Screening of agricultural areas can is essential (even 1-3° C. are important) to lower a crop and to leave many thousand people without livelihood and work. And hardly corresponding countries will allow similar experiments. Therefore it is necessary to use short-living particles or such particles that are capable to change their optical (or sizes, or phases) properties independently or under laser or electromagnetic actions, or by temperature changing, including said particles, but not limiting. For reduction of ability of darkening said objects can to change the form, color, rotation, to be scattered on a part, including but not limited. The laser can hot and vapor these particles, can to change their color, can to change their reflectance etc. Such objects allow changing the degree of darkening over agricultural regions. In some cases the darkening effect can be compensated (in full or in part) by means of the screen made from particles, transforming received UV radiation to the range of IR or visible radiation that is corresponded to more radiant heat. Such screen has to be located at the height of the ozone layer and is capable to increase the warm radiation of the ground surface areas that are lain under said screen. Such screen can be used in the case of Global cold shap.

FIG. 2E shows one of possible location of said towers that are capable to create the ascending streams of objects In FIG. 2E the circles show the location of said towers 7-10 km in height for delivery of said objects in area Subtropical Jet, daggers mark show the location of said towers 1-4 km in height for delivery said objects in area of trade winds. A part of passat-oriented (trade wind-oriented) towers can be located on sea platforms or sea vessels.

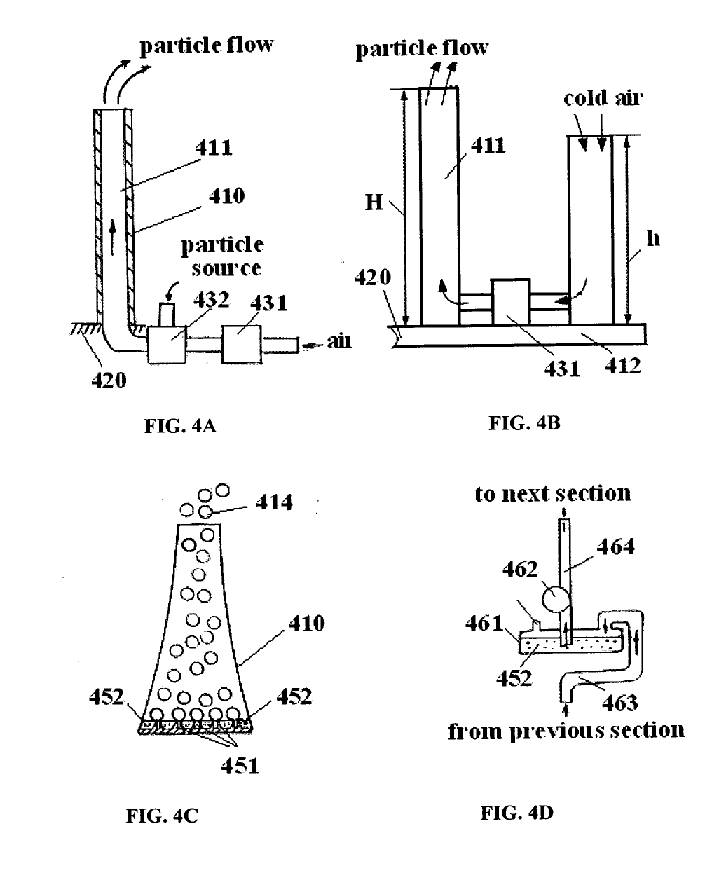

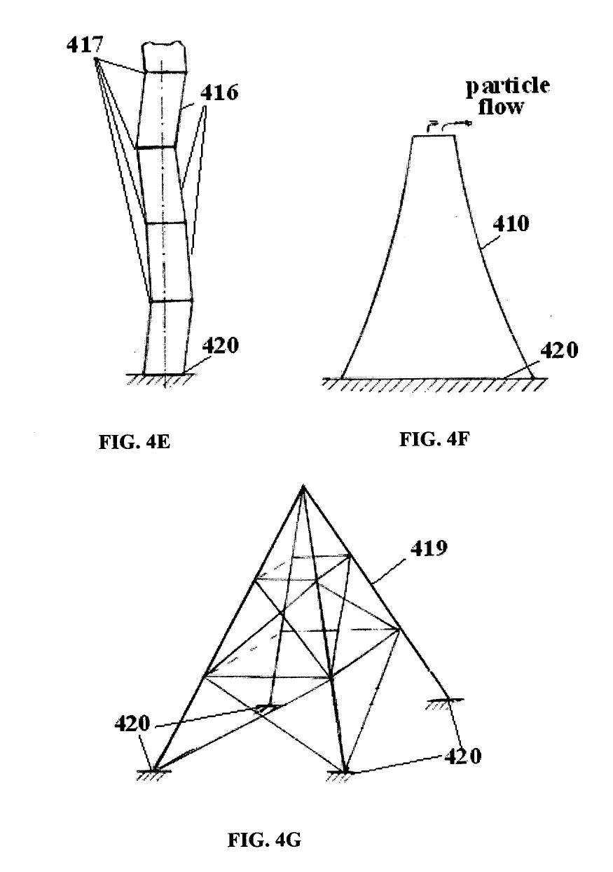

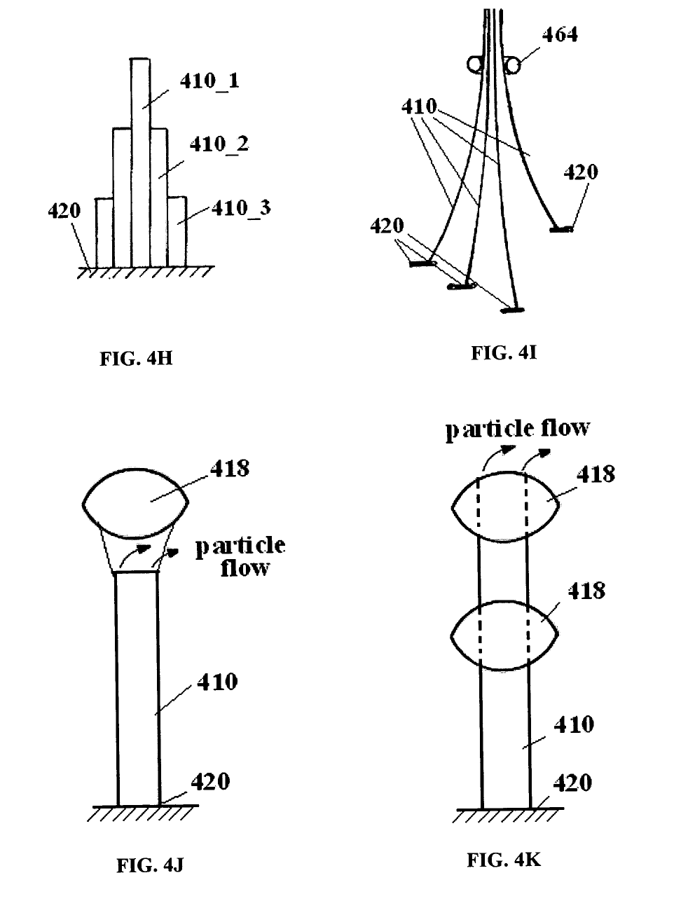

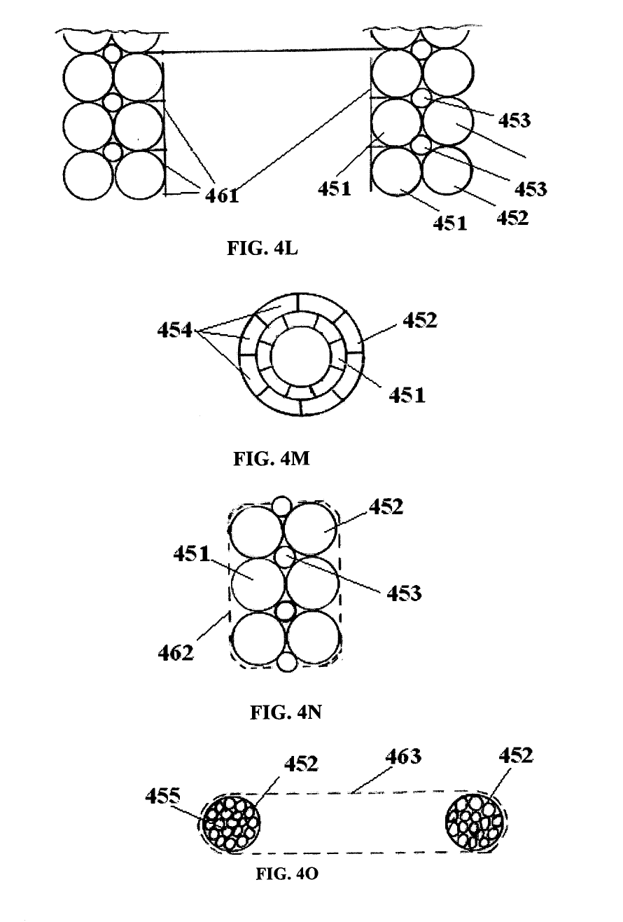

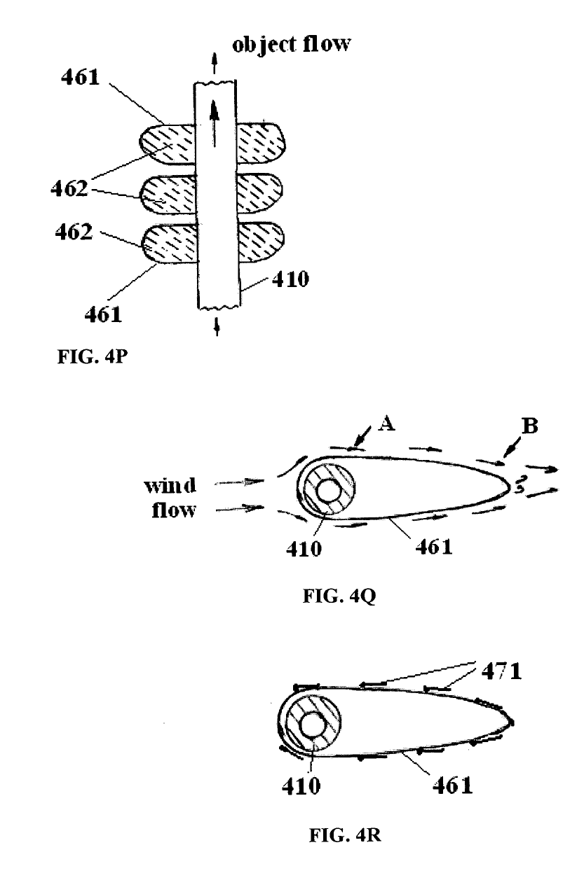

The stages 101 and 102 include to use said towers 410 (see below) having one or more through channels 411 (FIG. 4A-FIG. 4C). These towers can be mounted on the polar islands or ice arrays, natural or artificial, special vessels etc. Groups similar towers allow to create constantly operating ascending flows for delivering said objects in area of a constant or temporary wind stream (for example, on ways of movement “smog”) for creation of the darkening screens protecting a terrestrial surface from a sunlight.

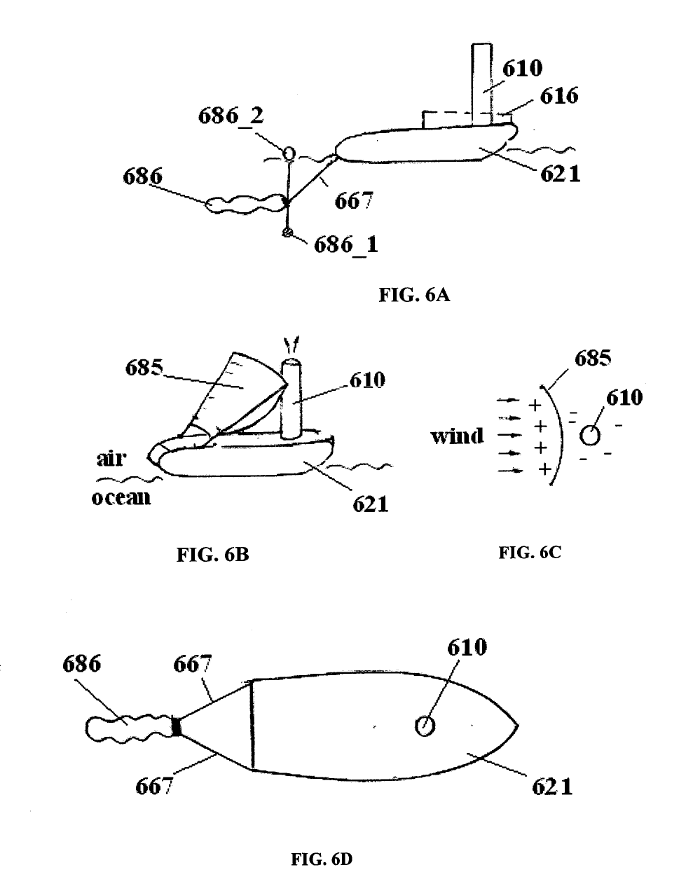

Irrespective of previous screens these new drop screens (103) located below in the areas of turbulence under clouds are created by means of cheap “roving” vessels that use only alternative energy (see below FIG. 6A-D). Only such requirements will allow to develop the sea vessels suitable for mass production and a big flotilla necessary for creation of said powerful screen. Numerous observations in seaports and researches S. Twomey defined requirements to such drops and such vessels (cheapness and autonomy) that allow to make similar “roving yachts” the necessary quantity and really to use theirs.

Actions said screens will influence not only on said dangerous region, but also on all planetary climate. Decrease in temperature of Atlantic can lead to one more result: to soften a climate, to weaken droughts and to reduce erosion of the western plains of USA according to models Z. Shubert (NASA Goddard Space Flight Center, USA).

The second group of stages (Local part, FIG. 1B and FIG. 3) is connected with struggle against concrete hurricane. FIG. 3 represents a common diagram of consecutive actions against dangerous hurricane using local means. It is shown a sequence of six main steps, since the step of hurricane formation to the step o coast protection. At each step the corresponding means are used. The basic idea consists in that to weaken or reject hurricane, operating gradually. FIG. 3 concerns to Atlantic hurricanes, but, visible, formation of hurricanes in other regions is occurred under the same script and the offered stages of present method can be used and there.

A process of Atlantic hurricane forming begins in mountains of Ethiopia (FIG. 3). A growth of storm activity promotes creation of heterogeneities in current of trade winds which in the further extend and accumulate energy. Even small influences, smoothing over these heterogeneities and accessible to us, can play a significant role in weakening these disturbances and, hence, hurricanes. A constant monitoring can be realized by using devices for measurement of intensity of electric atmospheric fields and frequency of lightning discharges. For activity weakening it can be used explosions of FAE (fuel-air-explosive) in storm area that allows to reduce frequency of lightnings (Kulakov I. et al), start in clouds 303 of set small-sized VHF generators (3-4 sm) of explosion type (Prischepenko A. et al.), creating ionized channel by laser pulses, powerful electromagnetic pulses etc. It is known many different ways for this goal, connected with using metallic bands or lightning rods pelted into clouds with rockets or aircrafts 311. It is useful to use also known techniques of struggle against clouds. These actions (111) will allow to smooth atmospheric heterogeneities and to complicate formation of hurricanes. The similar stage is and on tornado forming.

Further it is used local means, actions of which are defined by results of monitoring that are carried out by numerous stations, terrestrial, sea and cosmic. Their action allows to observe and analyze each hurricane from the moment of its occurrence and to accompany with it on all way.

It is known, that approximately within one day after it, flown by on northern Africa (dry land), a part of said heterogeneities can develop into hurricane. (Said dry land is not accessible practically to struggle against hurricanes, these countries are not interested in it). From this time it is necessary to try to predict a way of hurricane, and depending on its direction to make corresponding decisions independently or to request the corresponding countries. The hurricane weakening can deprive any country a necessary rain. Therefore realization of the subsequent stages (112-114) depends not only on technical opportunities, but also from predicted way of hurricane and opinions of corresponding countries.

The main task is to exclude the possibility that the hurricane can gained full force.

When said vortical disturbance has reached ocean and the hurricane has started to develop, it is necessary to sow (112) by fine dust particles (D. Roserfeld), for example, cement duct, from the plane as most simple and cheap means. It is used similar cement dust for dispersal of clouds.

If the regular control of the maintenance water vapors shows, that their quantity has reached the predetermined limit, then it is used more effective, but expensive means that are chosen from the followings: gel, dry ice, liquid nitrogen or iodide Ag, including said means, but not limited, and it is sowed said vortical areas by these reagents from above around. The control of the water vapor level will allow defining the moment of necessary attack. It is necessary to not pass this moment and to force using all possible means at least parts water vapors to condense, and further to repeat it whenever possible repeatedly. Probably indistinct result of program Stormfury has been connected also by that it is probably said moment has been chosen unsuccessfully

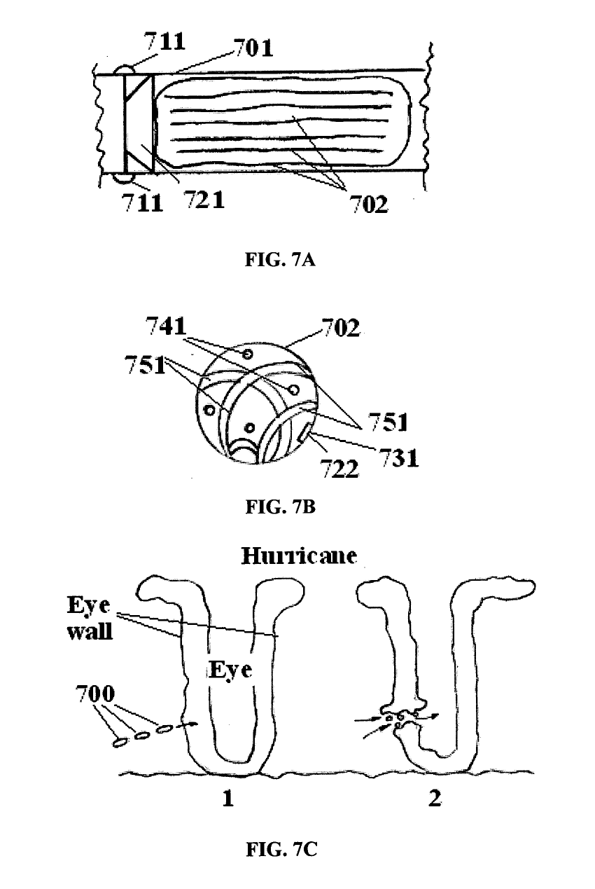

At the same time the attack by other means is carried out. At first, fuel-air explosive rockets (see below FIG. 7) attack this hurricane. These rockets break vertical structure, help to create “through windows” in eye wall of hurricane using the difference between the external pressure (˜1 atm) and the internal (in eye) pressure (˜0.9 atm) and weaken an electric field in a cloudy part of hurricane. These attacks can essentially to weaken the hurricane.

At the same time can be actions to hurricane structure destroying by the supersonic shock waves (115). The supersonic jet airplanes must create said shocks waves. The coordinated influence on hurricane by actions b4-b5-b6 will allow to achieve essentially greater effect, than from everyone.

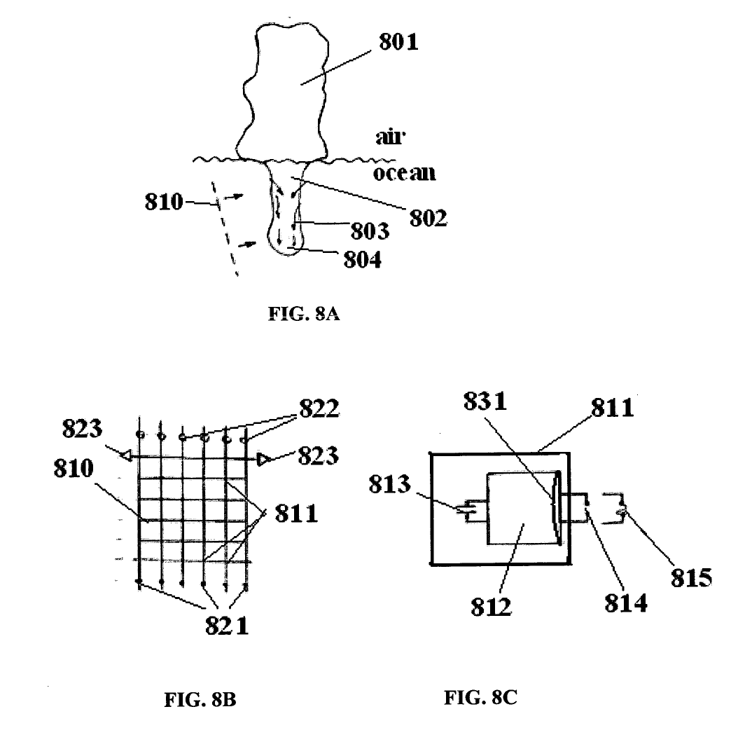

At the same time a net with set electro-hydro-generators (EHG) using Jutkin's effect (see below FIG. 8)—116 is airdropped from cargo aircraft. These EHGs are fixed in the net points and comprise energy sources—in advance charged super capacitors. When the signal of “explosion” then the energy of said capacitors discharges through spark gap or through metallic band or wire. This discharge is capable to create very high pressure in water and to create shock wave. Simultaneous actions of these generators are capable to cause very powerful shock wave which it is possible to direct in parallel to water surface or a little upwards aside hurricane. Such wave is capable to destroy underwater structure of hurricane on the big extent or even cut off the bottom part of hurricane from water surface. Both that and another should lead significant loss of energy. To straighten this network is enough to supply this net by floats attached from above, freights attached from below, and pair small independent tows for extension of said net.

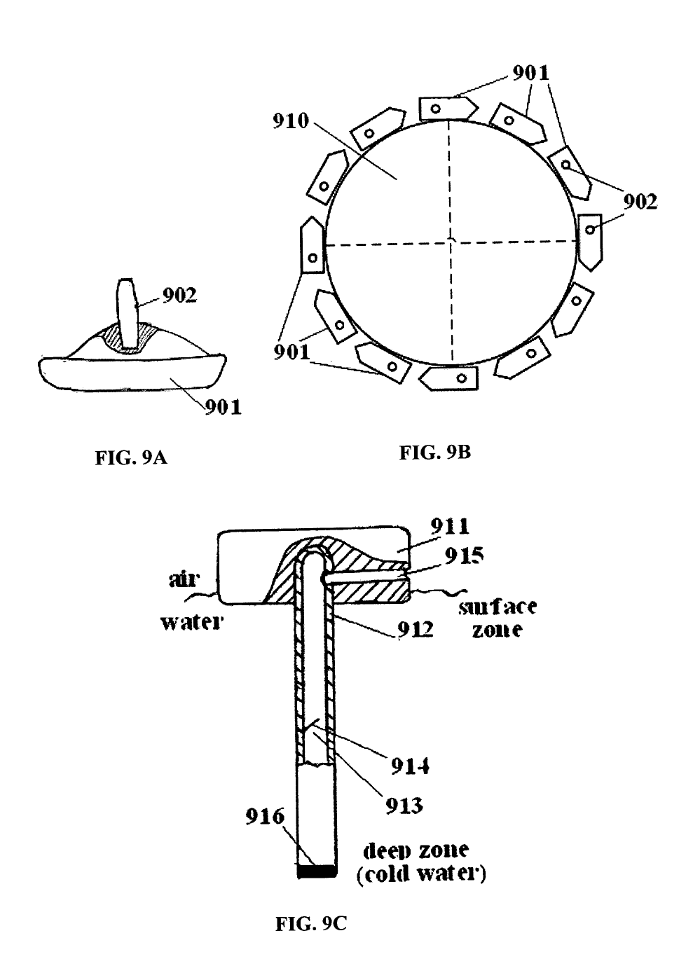

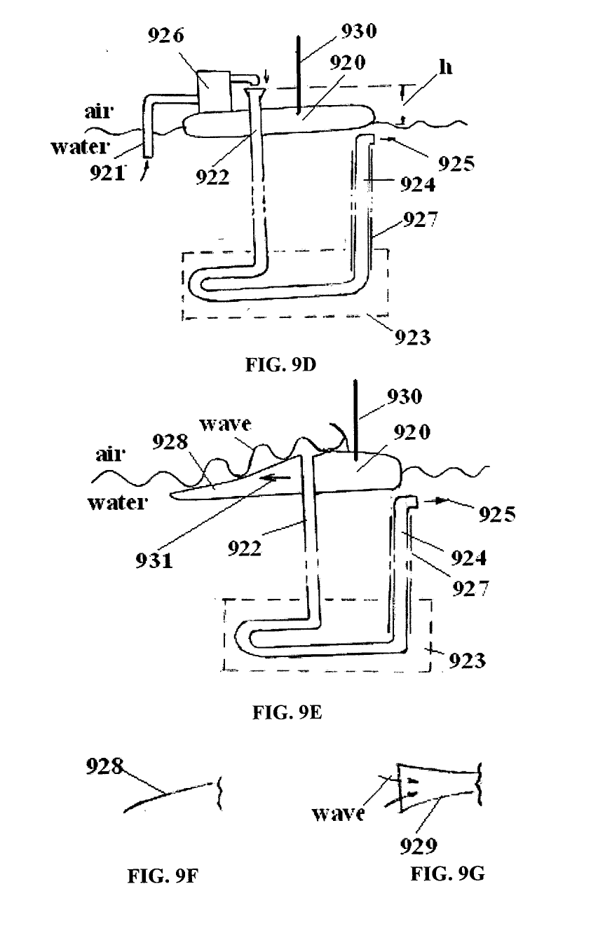

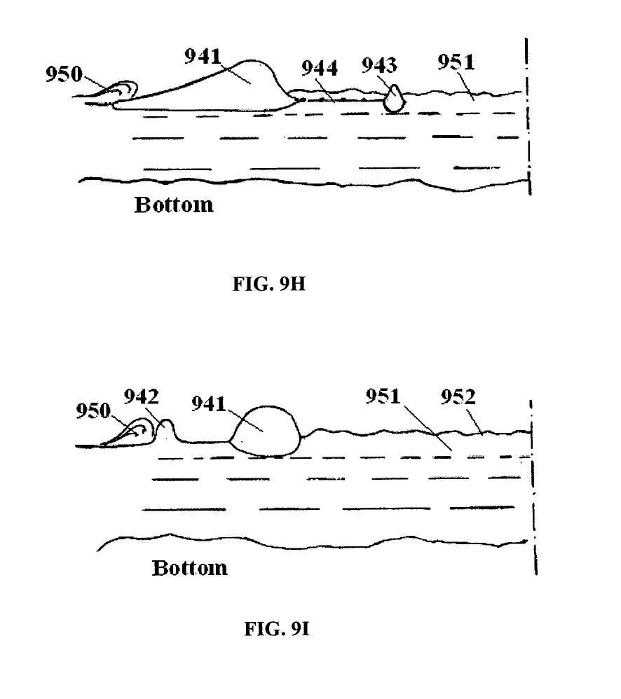

After or in parallel the barriers of hot ascending air flow (M. Alamaro) is created on a way of hurricane—118. For this purpose deliver by cargo planes or dirigibles the equipment (see below FIG. 9A-9B), consisting of boats on which are placed on one or more engines, and a group of sections, which big pontoon can be mounted from. Said pontoon is intended for fuel storage. Each group of boats and said sections are equipped by means of navigation and are capable to form the design consisting from big pontoon and moored to them in the predetermined order of boats. A group of such platforms it is established on a way of hurricane and creates powerful enough thermal barrier, capable some (˜10%) to weaken hurricane and even to reject it aside (113).

The delivery of said equipment can be carried out by aircrafts or dirigibles.

Independently, at the same time or beforehand a big group of water-pumps (FIG. 9C, B. Feldman et al.) or wave-driven (P. Kithil) devices, using upwelling for lifting deep cold water and cooling ocean surface, can be airdropped—118. These devices maybe airdropped so that to create one or more rows of said water-pumps that are located across or angularly to hurricane moving to weaken or deflect it (114). Yachts (FIG. 9D-9G) can be used also. Only such water-pumps that have flexible, folded or coiled pipeline can be transported and airdropped (Feldman et al, US Pat. Appl. 20070270057) at necessary time in the necessary place. Such water-pumps are capable are capable to lift cold water from depth more than 200 meters with a speed 1 cube of m/ceκ (for said pipeline that is 1 qu.m cross-section, Dunn S. et al). Let us assume that it need to cold an area in 400 km (front), 25 m (deep) and 2 km (across front). Let assume that temperature on the depth is equal to 15° C., and it need to lower temperature on 4° C. Therefore, it is necessary to pump over: 0.5*4*10E5*25*2*10E3=10E10 cbm of water from deep. If have dumped for 3 days it is necessary ˜40000 water-pumps. Let us assume that each of said water-pump has 300 kg, then their total weight is 1.2*10E4 tons. Such cargo planes of type AN-225 can translate for 100-200 flights. It is real. Such or more wider barrier can allow to weaken or reject hurricane. Thus it can be useful to create a lot of such cold strips, their form can be [symbol] to reject hurricane. Such delivery is carried out by aircrafts, dirigibles or ekranoplanes. Application Bristol cylinder hardly will be useful.

The form and location of said barriers, especially in the event that they try to reject hurricane, must be chosen in view of forecasts of development of hurricane and legal requirements.

Simultaneously with creation of said barriers in the form of strips of cold water it is desirable to create additional area of water having more high temperature (see below FIG. 9H-9I) from that other party. However, creation of such area demands time, and its retention during necessary time is problematic.

Above-listed actions can be some times repeated depending on development hurricane.

Further if hurricane has passed the set forth above barriers and comes nearer to coast, it should meet system of coastal protection on its way.

The riversides and its mouth (121-123) is protected preliminary irrespective of concrete hurricane, and for this protection it is carried out following actions:

c1)—preliminary mounting means for flood protection, including a creation of different protective structures along riversides etc,

c2)—preliminary creating passive antitsunami barriers in the form of bendable plastic (composite) artificial trees filled with water and/or sand,

c3)—preliminary creating active antitsunami barriers in the form of EHGs located in places of the sharpest lifting of a coastal bottom and that are capable at the moment of passage of a tsunami to create a shock wave of water that is capable to throw out in air huge weights of this water. These actions are described in our “Protective flood barrier system”, U.S. pat. appl. Ser. No. 12/316,249, Feldman B., et al.

Further, the protection of coast of the gulf as Mexico Gulf requires to consider two features:
1) the most part of the gulf water surface is covered by oil thin film which interferes with evaporation and promotes rise of surface temperature,
2) the powerful river Mississippi that flows into said gulf and carries continuously huge quantity (16200 m³/sec) of warm fresh water (that is easier than gulf water and, hence, spreading on surfaces of said gulf), and also contains many surface-active substances. Many known projects are not considered practically these features. The volume of water flowing into gulf is huge by comparison with possible productivity of one water-pump station (˜1 m³/sec).

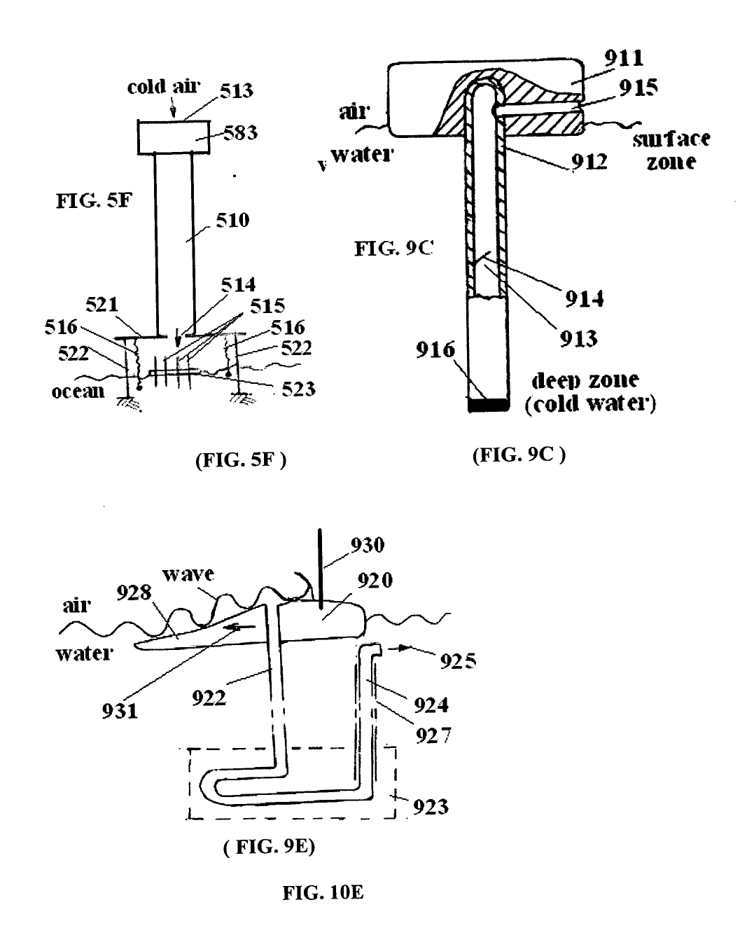

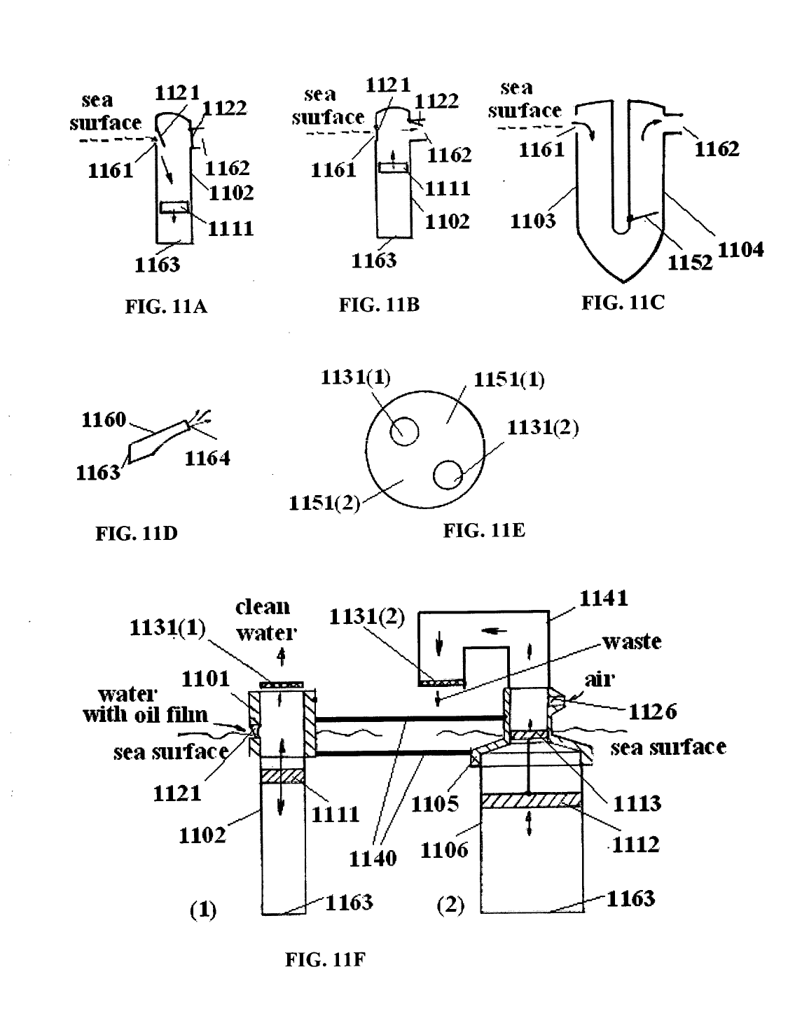

By preparation for hurricane season the gulf surface is cleared (124) from oil film at least partially by means of skimmers (see below FIG. 11), using wave energy. One or several rows of such skimmers move along said gulf surface by means of additional driving means. It allows to not admit an overheat of water surface and to lower its temperature on some degrees (C2) (see below FIG. 11). It is possible to use the wave energy for moving said skimmers.

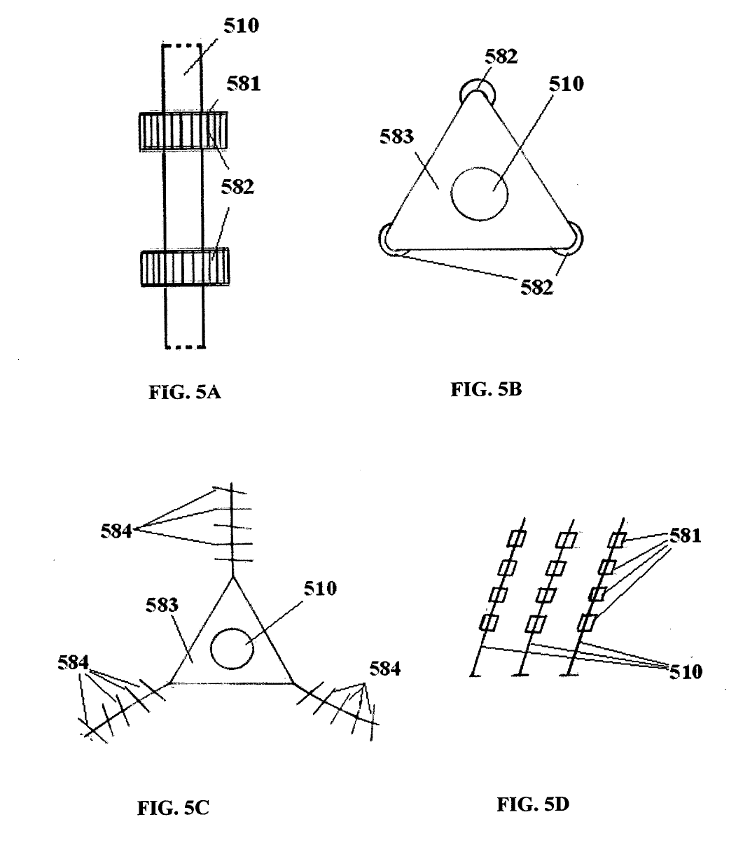

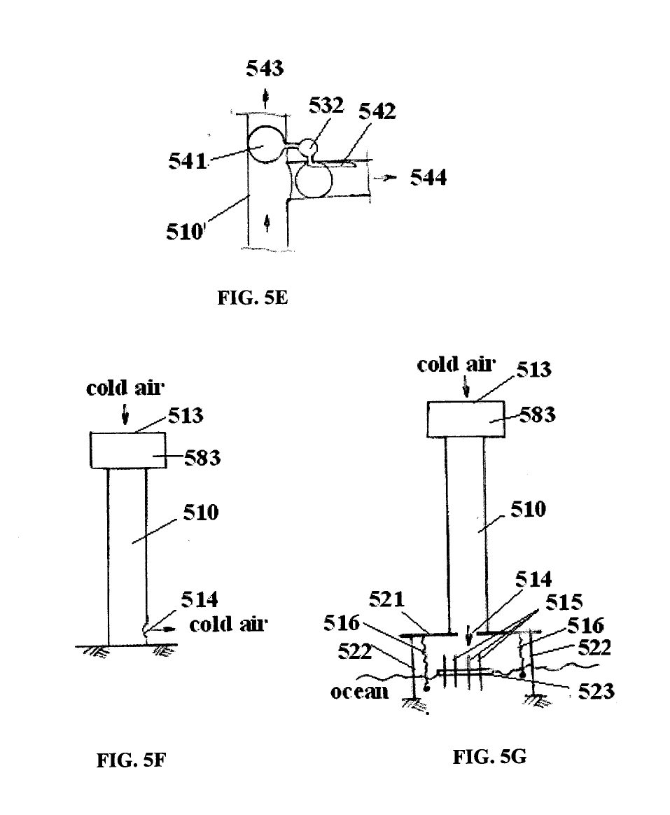

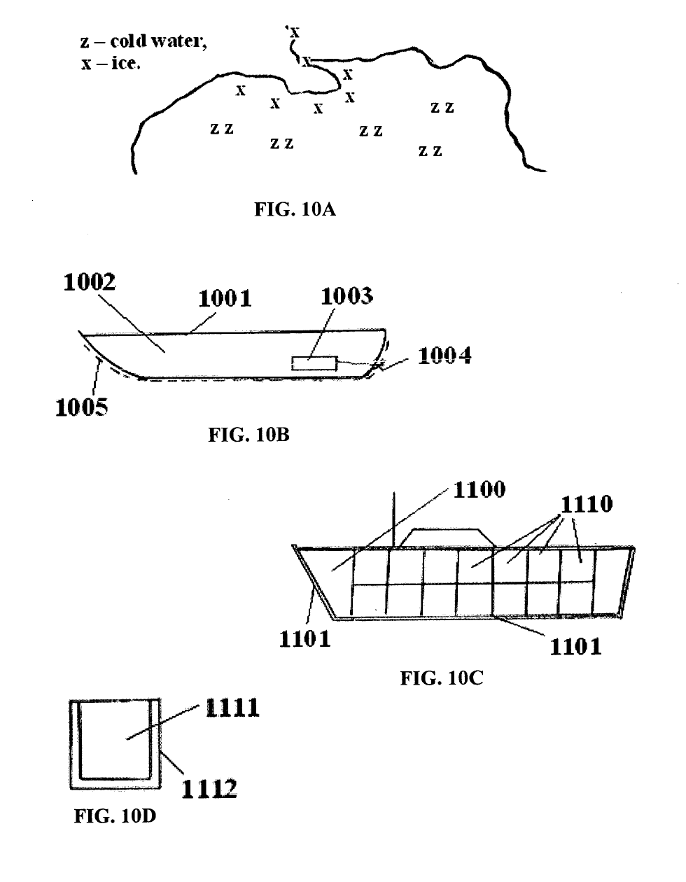

At approach of a hurricane season and further during the dangerous period it is cooled a sea surface (133) that is located near of possible hurricane ways. For cooling a gulf surface can be used the devices presented on FIG. 9C FIG. 5F FIG. 9E—see below) and for convenience repeated on FIG. 10C, and also any others. The choice of concrete types and quantity of necessary devices is defined by productivity, cost and depth warm surface layer. These actions differ by that it need a stationary field of cold water.

Cooling of river surface and mouth under such circumstances probably only creating a layer of cold water on the surface of said gulf. It is need that this layer should remain on river surface during the dangerous period, i.e. in several days. For this purpose it is offered to create ice files along the river (they can be located at the bottom in heat-shielding covering that can be easy break (or on coast), or they can be prepared in the form of icebergs, tankers with an ice or ice tankers, as FIG. 10B (see below) similarly to project G. Pyke (http://en.wikipedia.org/wiki/Geoffrey_Pyke). At approach of hurricane such tankers should be moved upwards on the river and anchored. Thawing ice will cool both river surface and the area adjoining to river mouth. For acceleration of thawing said ice files can be taken to pieces which also should be anchored or are grounded. Splitting can be executed by means of the calculated explosions. The tankers of 20-50 the tons' displacement can rise upwards on the river and take the positions. Such 20-100 tankers will give up to 5*10⁶ tons thawing water, or recalculation on 22° C. water (26−4=22) is equal 2.7*10⁷ tons, or at thickness of a layer 10 cm corresponds to squire in 270 sq. km. It can be enough for protection of the river, and another way it is absent. FIG. 10A shows the provisional (integrated) arrangement of sources of cold water on example of Gulf of Mexico.

A possible cost of ice delivery has the order 0.1 $/m³ by delivery iceberg having size, equal to 10¹⁰ m³ (to California). Delivery of an ice is possible or in the form of integral files (icebergs) or in the form of metallic containers, tanks, hulls of sea vessel etc. that are filled with the ice, and said ice thawing inside said hull (tank, container), cooling surrounding water et the expense of heat conductivity of metal. The effect of last variant is less, but fresh water can be used separately. Of course, said hulls must be block out corrosion.

Besides, for cooling it can be used descending cold air flows with the help of said towers. placed on the water ships or sea platforms (124).

It is known that darkening screens allow Global Warming to weakening. As noted above it is necessary to create screens of three types:
long-living, created by objects (or particles) flying in atmosphere and capable to make it is a lot of turns around of Earth without loss of blacking out properties,
short-living, created by the objects, blacking out characteristics of which fall at approach to predetermined border,
transforming, created by objects, transforming radiation of one part of a spectral range into another.

The objects are chosen from the followings: aerosol, the smallest ice particles or snowflakes, small paper or thin reflecting plastic airplanes, small reflecting inflated balloons, soap bubbles, frozen soap bubbles, special particles, magnetochromatic microspheres placed inside said special aerosol particles, said small ice particles or said balloon envelops and that are capable to change their diffractive color under magnetic field influence. Opportunities and lacks of aerosols, in particular, sulfur oxides are known enough. The smallest ice particles or snowflakes or soap bubbles, their combinations can appear the most natural and the harmless decision. Said frozen soap bubbles have envelops, having enough high plasticity.

The small paper or thin reflecting plastic airplanes, small reflecting inflated balloons, soap bubbles, especially the last, including said particles, but not limiting, are suitable as short-living particle. The aerosol and ice particles are more suitable as long-living particles.

The long-living objects that are characterized in that a most part of them is capable to be to remain in the air flow and to change their darkening properties under external actions but so that they can restore these properties at any time after. The opportunity to operate optical properties of particles for use in long-living screens is already proved by researches. A group of Bartosz Grzybowski (Evanston) could unite gold nano-particles with the thread-like molecules named MUA. Under action of an ultraviolet these molecular strings change the form and are polarized, forcing said nano-particles to gather and to change color. The color of these particles depends on their distance among themselves. If particles are removed from each other the material has red color, at approaching them—it material becomes colourless. The time of color preservation depends on quantity of the molecules connected with everyone particle. Varying concentration, chemists can change time of visibility from hours to several days. An intensive visible light or heats erases the image much more quickly about several seconds.

The inflated balloons and soap bubbles can be filled with air or its mix with light gas (natural gas, CH₄, helium, hydrogen) or different their combinations. A soap solution ratio influences on the lifetime. Low temperature and low humidity as in FIG. 4B etc. allows to create long-lasting bubbles. Light snow (isn't shown) allows to create the centers of crystallization (freezing), keeping bubbles at the initial stage.

For increasing dispersion of said objects (in particular, balloons and bubbles) in wind flow these objects can be electrified, using for example a plurality of sharp spikes connected to an electrical source that is chosen from followings: wind energy, piezo cell, solar cell, including but not limiting.

The use of small reflecting inflated balloons and/or soap bubbles allows to install their lifetime, both selecting their parameters, and destructing they by a laser beam.

These soap bubbles can be generated at any level, in particular, at ground level. They can be accelerated by a small difference of the pressure, created by a wind in area of the top aperture. It is possible that the soap liquid for creation of said bubbles and light gas for blowing they can be lifted by pump through corresponding channels and said bubbles are blown there. These balloons and bubbles can be lifted by own lifting force. The positive temperature in said liquid can be supported using wind energy, sun cells, piezo cell into flexible envelop, including but not limited.

FIG. 4A and FIG. 4B show said tower 410 having through channel 411. This tower 410 is fastened to a foundation 420. A pump (air compressor) 431 sucks in air (“air”) through its inlet, passes through a mixer 432 wherein this air mixes up with the said objects (particles) passing from source of particles (“particle source”), and then forces by the pump through channel 411 and forms a stream of particles which spreads and carried away by said wind stream, creating darkening screens. Height H on FIG. 4B corresponds to height of said wind stream (in particular, jet stream or trade wind). At use the smallest ice particles or snowflakes it is desirable, that used air would have negative temperature. The embodiment that is shown in FIG. 4B stipulates it, where air is sucked in by means of second tower 412 having through channel, an inlet of which is located at the height “h” corresponding negative temperature of air. This allows to keep particles of an ice during their rise and even to facilitate formation of ice particles or soap bubbles. The height “h” can be less, than H, is equal to it, or even it is more. Water drops of the dosed size can be injected into cold air flow. It allows or to exclude losses of energy by freezing or it is essential to reduce.

FIG. 4C shows schematically a variant of a design for formation of said soap bubbles flow 414. The lower part of said through channel (inside said tower 410) a plurality of nozzles 451 for forming said soap bubbles are placed. Around said nozzles 451 the soap solution container 452 is located. In the area of low temperatures (−7° C. to −15° C.) said soap bubbles freezes, and their envelops become stronger and plastic. Combining said solution composition and light gas parameters it is possible to achieve navigation of bubbles at the predetermined height and during predetermined time. For maintenance of the best dispersion said bubbles said tower 410 can comprise ionizing or electrifying elements (are not shown). FIG. 4D shows one from several sections that allows elevating the soap solution. This section comprises a tube 463-464. The 463 is a lower part of the tube belonging to this section, the 464 is upper part belonging to previous section. Through tube 463 said soap solution is exhausted from previous section to container 461. The pump 462 exhausts further said soap solution from the container 461 to next section through tube 464. Two tubes 451 (light gas under pressure) and 452 (soap solution under pressure) are fastened to a support 413 (a mast or tower wall).

An internal diameter of said through channel 411 depends on used particles, for example, for ejecting of aerosols enough to have 1-2 meters in diameter. Same diameter is sufficient for other types, except for Soap bubbles. For bubbles smaller diameter (only for rising of a mix) is sufficient.

For stabilization of its vertical position said tower 410 can use depending on requirement height and using real materials one or following designs:

1) a free-standing tower (FIG. 4E), comprising pneumatically inflated flexible torus-like sections, that are actively controlled and stabilized by gyro-stabilization,

2) a free-standing tower, comprising a plurality of pneumatically inflated toruses (FIG. 4F), the weight of said tower is at least partially compensated by light gas and its stabilization is supported by resiliency of its tower,

3) a solid pipe made of plastic (composite) reinforced by high material, for example, on the base of carbon tubes (FIG. 4F),

4) a lattice wall structure of the tower in the pyramidal (FIG. 4G) or hyperboloid form (mast), including said form, but not limiting them, and these structures are made from a plurality of tubes or rods 419,

5) a combination including a central solid pipe and surrounding it pneumatically inflated structure.

The first embodiment (FIG. 4E) can be used for high-altitude wind flow, but is stationary and more expensive, the second and the third embodiments (FIG. 4E) are limited in height, but simpler and cheaper and are intended for medium and lower heights. The mast design FIG. 4G comprises through channels in the form of tube that are fastened to one or more main rods (or tubes) 419.

FIG. 4H represent tower that comprises one or more solid pipe 410 made from high-strength solid composite, fastened to foundation 420. Assemble, comprising more than one such pipe that have through channel (FIG. 4H and FIG. 4I). It allows to increase stability of such tower, and to have more than one top outlets that are located at different heights. Separate pipes 410_2 surround the central pipe 410-1, and pipes of the third one 410_3 surround pipes of the second row. Such location allows to use wind flows moving at different heights. For stability touching surfaces of walls (FIGS. 4H and 4I) can be covered by glue or gecko covering and be strapped by is high-strong tapes (are not shown). At modern materials the design is steady enough. The embodiment FIG. 4H allows easier to sustain useful parity S(h)*P(h) const. Such condition allows to lower resistance through channel to the ascending flow and accordingly to reduce requirements to the pump (see FIG. 4A).

FIG. 4J and FIG. 4K represent an opportunity of support designs of types FIG. 4F in vertical position by means of dirigible-like torus 418 filled with light gas.

FIG. 4L shows as an example section of the tower FIG. 4F made on a thin film basis. In this case the thin pipe 461 forms a central through channel for ejecting said particles. A thin wall of the pipe 461 is fastened to inflated toruses 451 and 452 which form the central element of the said tower and located in each row (FIGS. 4L and 4M). Each row can comprise two or more said toruses that are densely pressed to each other. Between each pair of said rows small torus 453 is located, interfering moving of the next layers of said toruses relative each other. It can be either continuous torus, or balls filled with gas under more high pressure, or torus-like stocking executed in the form of grid in which the said balls are placed. Diameter of section small torus (or accordingly, diameter of said balls) is a little bit more, than (√2) *D, where: D-diameter of torus 461 (462), and the size of cells of said grid is less, than diameter of said small torus. All little torus are under overpressure, than bigger toruses.

All toruses are divided by vertical partitions into identical sections 454 (FIG. 4M), that interferes with pressing-out of gas-filler and moving of said gas-filler aside, opposite to an inclination, at rocking tower. Otherwise, the movement of gas will increase the deviation of the tower. All greater toruses are connected with each other by: glue, welding or gecko or by means of connecting flexible and strong tapes 462 (FIG. 4N). Use of the said stocking allows pressing most densely surfaces of greater toruses.

The greater toruses 452 (451) can be made also in the form of the strong stocking 463 filled with by balls 455. These balls are filled also under overpressure with light gas or air. Diameter of these balls is much less, than 452, and the sizes of cells of “stocking” is less than said diameter of the balls 455. Such design allows to raise reliability as the broken one small ball is not capable to affect seriously on tower structure and danger of overflowing (FIG. 4O) is eliminated. Besides, uses such stocking forms corrugated surface and reduces aerodynamic resistance.

The height said tower can be reduced due to use of shapers of vortex (dr. Wood's box) or twisting an ascending stream, or ascending flow is accelerated on separate sites or on all extent of the said channel by means of the electrostatic field created by electrodes, placed on an internal surface of the said pipe or thin conductive grids, and also at use of “objects” filled by an easy gas, which rise and reach predetermined level, defined in the parameters of sais gas and an envelop.

Various solid aerosols (on the base of glass, Al etc.) can have sufficient strength, density 1-5 kg/cbm, and can be by filler for filling said toruses. Such filler increases stiffness of the tower. Filling pores of said solid aerosol with light gas allows additionally compensating the weight of the tower.

The tower FIG. 4F is self-supporting within the limits of heights. Stability against the inclination is defined by the area of the horizontal cross-section (quantity of toruses 451, 452, located in one row, diameter of toruses, materials and the foundation 420.

The possible deviation from a vertical defines admissible height of the tower FIG. 4F. It depends, in particular, on pressure of a wind. FIG. 4P-4R show a possible way of essential reduction of wind pressure. Thereto, a plurality of torus-like balloons 461 made from rubber-like light-tensile gas-tight plastic (composite), for example “elastomer” are fixed along an external surface tower 410. These balloons 461 are filled with air or gas 462. Under action of a wind these cylinders are extended, accepting the drop-shaped form (FIG. 4Q). FIG. 4Q shows, as wind flow extends these balloons. This form allows decreasing the aerodynamic resistance in 10 and more times. It occurs because the extended form leads to removal of area of transition of a laminar flowing around stream (the left part) to turbulent (the right part) from area “A” (at absence of the cylinder 461) in area “B” (at its use). Simultaneously the share of an entrance wind flow transformed to turbulent flow decreases. This transformation defines a value of wind pressure. Further, it is offered to place a piezoelectric film, for example, made from polivinildendiftorid, on a surface of these balloons 461. This film is capable to be deformed at electric voltage action and, deforming said surface of these balloons 461 to promote displacement of the said point of transition and to reduction of aerodynamic resistance. As the wind can change direction, it is necessary this voltage to submit to the corresponding places. For this purpose the system of addressing is provided, each place, for example, conditionally plate 671 (FIG. 4R) is connected separately to (for example, by printed conductors) to the multiplexor (it isn't shown) connected to a control device, receiving data about the wind direction from corresponding sensors. These devices can be places between two neighboring balloons (they aren't shown).

The various coverings reducing aerodynamic resistance of a surface are known. For example, “riblet” containing the external surface of Airbus 380.

FIG. 5A shows that in around narrow tower 510 (in case of FIG. 4E and FIG. 4F) wind energy generators 581 with vertical axis and blades 582 (vertical, inclined or figured) can be placed. Concentrators (not shown) can direct an additional air flow to said blades 582. Flexible structures FIG. 4E should have on a surface cylindrical rings on which the stator winding is located, the rotor can use neodymium magnets as like Maglev, the same magnets can keep the device on weight or on a special ring. FIG. 5B (cross-section) shows one more embodiment wherein on one floor of vertical structure the holder 583 is placed, and a group of wind energy generators are fixed (FIG. 5B).

FIG. 5C still the second variant, in which the set of small propellers is attached to the specified holder 583, 584 for electrical generators with a horizontal axis as Selsam (D. Selsam) can be placed. FIG. 5D shows a “tree” of similar devices. They borrow not enough places on a surface of the ground and will allow receiving enough electric power. Necessary cables can be arranged in the through channel. And, at last, such generating structure is easily interfaced with above-listed structure for creation of darkening screens.

FIG. 5E illustrates a possibility of switching said ascending air flow from one outlet 543 to second 544 and back with the help of inflatable balloons-valves 541 and 542. The pump 532 controlled from below closes necessary valve.

FIG. 5F-G shows the opportunity of one more use of said tower. On top tower 510 the pump 583 (the soaking up pump can be located and below) fed from sources is located. Said pumps over cold air from atmosphere (the corresponding height) through the top aperture 513 downwards and throw out at near the surface of the ground or water through a lower aperture 514 (or even in the top layer of water). Similar devices can be used, where other opportunities are absent, for example, for cooling thawing ice files, for cooling water surface, for cooling the places dangerous on methane emissions, etc. From one pipe (said through channel) it is possible to expect a volume of cold air about several m³/ceκ. FIG. 5G shows the example of use of said tower for pumping over cold air to water surface. The tower 510 is established on a sea platform 521 which is fixed by columns 522 on a sea-bottom. The space “deep-freezer” by walls 516 is inside separated. Inside of this “deep-freezer” are fixed (for example, on a raft) metal rods (it is desirable, from Cu or Al), bottom ends of which are lowered in water, and top in cold air. In this variant the compressor can be established not upwards, and on a platform, receiving energy from wind generators, mounted on said platform, or fuel. The height of said tower 510 can be from 2500 meters up to 4000 meters (area having the negative temperature).

S. Twomey has shown that dispersion of small droplets of sea water in the turbulent air layer located at once under clouds will lead to bleaching of clouds and will raise their reflective ability. Supervision in seaports, where it is a lot of sea-crafts, have confirmed it. S. Twomey has defined that drops should be the micron sizes. S. H. Salter offered to create a plurality (million) yachts which will be supplied by generators of drops and by that though partially to interfere with ocean heating. However, judging by the project (S. H. Salter, J. Latham, The reversal of global warning by the increase of the albedo of marine stratocumulus the offered yacht is enough expensive design.

The offered design of the yacht 621 is represented in FIG. 6. The yacht should be enough wide, for example, having a catamaran's form. An energy source can be made in the form of elongate rubber-like pipe 686 closed from two ends and kept under water by special ballast 686_1 and a float 686_2 (if necessary), as like “Anaconda” (F. Farley, R. Rainey, J. Chaplin). In pipe the electrical generator is located (not shown). Sea waves compress this pipe periodically and produce electrical energy. The pipe 686 is connected to the yacht 621 by cables 667 (FIG. 6A and FIG. 6D). Said yacht 621 has a sail 685 (FIG. 6B). The sail 685 is connected with navigation means, comprising a control unit (is not shown), connected with GPS, allowing to operate said sail which this yacht and said rubber-like pipe 686 moves. A leeward side (FIG. 6C) of the sail the vertical pipe 610 for ejecting said drops is placed. In case of heavy wind said sails and said pipe are folded automatically, accepting position 616 (FIG. 6A). It is possible to expect that this generator, as like “Anaconda”, can be generate an order 0.5-1.0 MW that it is enough for management of said sail, said rubber-like pipe, and a drop generator. Such drop generator can be chosen from the following: piezogenerator, ultrasonic or mechanical generators. The estimation of possibilities of the piesogenerator that is made in the form of printer heads shows further. A minimum size in Epson printer drops is 3 picoliters or 10-15 μm (diameter). A maximum frequency is 1 MHz presently. A nozzle power is 2.5 mW (Brother). A maximum quantity of said nozzles is 10000. Correspondently: the necessary quantity of inkjet heads (N) is equal to:

N=10 litres/sec/(3*10−12 litres*105 sec−1*104 nozzles/head)=3300 heads,

that corresponds to 7.5 kW. The quantity of heads can be increased, their parameters also. Its technology is mass. Its raw material (sand) is cheap. If it will be possible to reach the maximum speed (frequency) then the generator having 10000 heads allows providing up to 300 kg of drops. Thus there is enough capacity the pumping drops upwards. The vertical pipe can be executed from flexible thin plastic (composite) or in the form of a pipe from a solid material. The set of similar yachts can circulate on ocean, weakening its heating and accordingly interfering with warming.

FIG. 7A shows FAE rockets (FIG. 7A) wherein for struggle against hurricane and tornado in the conditions of fast moving air flows. This rocket housing 701 comprises a balloon 702 that is placed into rocket housing (a fragment 701 of said housing is shown). The balloon 702 has a thin flexible gas-tight extendable envelop, filled with FAE—Fuel Air Explosive (for example, ethylene oxide). This balloon 702 allows excluding such case, when said fuel will disperse in rotating air of hurricane structure, having not had time to reach explosive concentration. The balloon envelop (FIG. 7B) comprises of embedded expanding means, for example, shape memory alloy, resilient plastic, whalebone, or tubes 751, connected to compressed gas containers (as in life jackets, isn't shown). These tubes are located so that said balloon would be expand to predetermined volume and thus to suck in ambient air from atmosphere inwards said balloon that it has there mixed up with said fuel and could form a mix of inflammable concentration without disturbance. FIG. 7B shows said expanded balloon 702, embedded tubes 751, and through holes for sucking in air 741. Said housing 701 includes a sensor 711 and a booster 721, connected to said sensor 711 and intended for breaking this housing 701 and releasing said balloon 702 that is filled with FAE. Said balloon includes also a sensor (or timer) 731 connected to FAE detonator 722. Said sensor allows waiting for predetermined flammable concentration, and said detonator allows exploding this mixture. FIG. 7C shows an expected result of said rockets actions. The first step: the flow 700 of said rocket penetrates into hurricane wall (1), the second step: FAE blows up, breaks structure of a rotating wall stream, helps formation of the through channel and weakens electrical conditions of rotating cloud forming hurricane.

Simultaneously, in the assumption, that an air part of hurricane 801 (FIG. 8A) accompanies with a underwater whirlwind 802, a disorganization of a underwater whirlwind by a shock wave is carried out. For this purpose airdropping a net 810 that is in the combined condition is carried out. Then stretching means (floats 822, freights 821 and tows or independent submarines 823) straighten this net (FIG. 8B) so that this net 821 would hold a position 810 against underwater whirlwind 802-803-804. In net units 811 are located well-known electro hydraulic generators (EHG) 812 (FIG. 8B and FIG. 8C). Such EHG comprises an energy source in the form of preliminary charged super capacitor 813. A spark gap 814 (or a metal tape 815) is placed between two electrodes acting from the said case 811, opposite to the concentrator 831. At the simultaneous turning on all these generators arises a powerful shock wave which can disorganize structure 802, and therefore to complicate changing energy between the air part 801 and the underwater part 802. On FIG. 8A the descending water stream 803 and the chamber 804 is shown. The form of this net should concentrate the shock wave (is not shown).

FIG. 9 illustrates method distributed delivery equipment for creating hot ascending air flow. For duly delivery of said aviation engines and formation of a floating platform it is offered to use two types of floating modules—for engines and for said platform in the form of pontoon. FIG. 9A shows the boat 901 made according to “lifeboat” ideology. Said aviation engine 902 is mounted (nozzle upwards) on the boat 901. Necessary quantity of such boats are airdropping in the necessary area. FIG. 9B shows the pontoon 910 of the flexible plastic (composite). This pontoon comprises a group of sections (not shown). These sections are filled with fuel and are capable to be assembled in the uniform pontoon, and said boats are capable to be moored to said pontoon and are capable to unite a distributed fuel system. The pontoon 910 can consist of several independent sections. Each boat 901 and each section of a pontoon 910 is equipped by moored units, GPS, navigating means for approaching and mooring, system of distribution and supply of boats by fuel, and a control system. The pontoon 910 can include means for preservation of vertical position at reduction of quantity of fuel; for example, filling buffer chambers with air (it isn't shown). Really boats weigh about 10 tons, and the pontoon with 720 tons of fuel can include 8 sections on 90 tons.

FIG. 9C shows the wave pump station according to US Pat. Appl. 20070270057 (Feldman B., et al). A long pipe 911 is fastened to float 911, made of bendable material and having freight 916 located on lower open end of said pipe. Said lower end having a through opening is located in the deep zone. Said pipe has a through channel 913 and connected through a valve 914 to outlet 915 and atmosphere. At lowering said pipe the valve 914 is open and said pipe is filled with cold water through open end 916, further when said device start to rise, the valve 914 is closed and water trunk inside said pipe 911 begins and this water trunk continues to move by inertia and is splashed out through on aperture 915. Cold water is lifted by each pumping from deep zone. Using of the bendable pipe allows operatively to transport and to airdropping this device. The similar design is offered P Kithil (US Pat. Appl. 20080175728). Both these of type of devices suppose fast transportation by existing means. The wave-pump sprayer is not shown.

FIG. 9D-.FIG. 9G shows yet other embodiment of an yacht or simple catamaran 920. It comprises a pump 926 (FIG. 9D) that lifts water from ocean through tube 921 to a level “h”. Said pump 926 can use an energy source that can be made, just as it is shown in FIG. 6A (626). A value of “h” depends on a temperature difference between a zone where a heat exchanger 927 is located and surface level. Let us suppose these temperatures correspondently 10° C. and 26° C. Further, neglecting the value of salinity, denoting the height of the right column—H and cross-section—S, we obtain, equating the weight of the left column of warm (in the figure) to the weight of the right cold:

(H+h)*0.99652 t/m³*Sm²=H*0.99973 t/m³*Sm², or

H*(0.99973−0.99652) t/m³=0.99652 t/m³*h.

If H=400 m, then h=1.3 m. Adding 2-3 meters to overcome the resistance of pipes 922 and 927 and heat exchanger 923, we obtain value h˜3-4 m. This small size and if h˜3-4 m, then more heavy water in column 922 pushes water up to communicating vessels 922-924 to the outlet 925. Further this water passes through a heat exchanger 923, where it is cooled almost too ambient temperature (10° C.). The pipe 924 should be covered with insulation 927, so water cannot heat up inside the pipe. An insulation of pipes 922 is not required. Thus this device can lift cold water on the surface, expending little energy. Such device can stand still or move around, using, for example, sails on the mast 930 (not shown). The following embodiment (FIG. 9E) does not require energy to lift cold water. For water lifting it is used a wave energy with the help of a concentrator 928. The concentrator profile corresponds to the project LeVirta “DAM-Atoll”, for example. Lens-like profile (FIG. 9F), narrowing wall (FIG. 9G) can increase in several times an action of waves. Thus, this device can do without the pump. The device can be anchored, and can be equipped with a wind engine 930, which moves in the direction 931. It is possible variant on the base of FIG. 6A.

The device presented in FIG. 9D-9G essentially differs from the device offered in above-mentioned patent applications of Bowers et al. There (for example, FIG. 1 and FIG. 4, US Pat Appl. 20090177569) warm surface water rises on a ramp 475 above a level 145, falls due to this rise downwards, passes through a pipe 125 and flows out through an aperture 155. This pat coincides with that that is shown in FIGS. 9D and 9E, correspondently 928 (926) and 922. However, the following way of warm water is essentially distinguished. Warm water (Bowers et al.) leaving the pipe 125 and rises upwards due to convection. Thus on a way, the length of which is the order of 200 meters, it gradually mixes up, its temperature raises and its speed falls. Therefore cold water can reach a surface only when all 200 meter layer will have been cooled. In the offered variant cold water at once gets in a surface layer and gradually cools just it.

By creating cold water barriers on the hurricane way it is useful to establish a zone of heated water from the side, to which it is desirable to move said hurricane. FIG. 9I shows a fragment of the boom-barrier 941 that is surrounded a zone 951 having more warm water surface. Surface warm waves 950 lift along inclined surface of said boom 941 and falls get internal zone 951. An additional boom 943 connected (fastened) to said boom 941 by solid lattice 944 that does not allow the warm water to return back. FIG. 9J shows the fragment of the boom 941 that limits a water zone 951 covered by oil film 952. The additional boom 942 fastened to said boom 941 by solid lattice (it is not shown) is a breakwater. Such design can be create but it is difficult its stability during necessary time period. Such design can also protect the internal layer of thin oil film. When the danger has passed, the thin film may be at least partially assembled with the help of skimmers.

A fragment of the Gulf of Mexico map is shown in FIG. 10A. Signs “x” show a desirable location of ice files. Signs “z” shows the positions of devices for cooling waters with the help of raising deep cold water.

The ice can be delivered in area of mouth Mississippi in the form of icebergs or by the means self-driving ice ships, as for example: FIG. 10B illustrates ice vessel 1001, consisting from ice array 1002 and having an embedded driving module 1003 with screw propeller 1004. The ice hull of this ice vessel is covered by heat insulating covering 1005. The set of different variants of ice delivery from polar areas in warm areas is described. Some of them can be used also.

FIG. 10C represents other variant of ice delivery: with the help of container ships (or lighter ship) 1100. The container ship 1100 is loaded by a plurality of containers 1110. The case 1101 of said container ship is made from heat insulating material, which interferes with thawing of ice. Such containers (FIG. 10E) can be filled with briquettes of an ice in polar areas, then being loaded in the container ship they are transported in dangerous area (for example, in area of mouth Mississippi). There said container ship is unloads, all these containers supplied by means of an anchor (or intended for grounding), are transported by tows on the predetermined places where they cool by surrounding water due to the thawing ice located inside. Such containers can be used repeatedly. Efficiency of such variant below, but the opportunity of using fresh water is essential interest. One more technological is possible also, but less favorable variant: filling of containers in polar area sea water, then freezing of water, and delivery of such ice in dangerous area.

For ice transportation the old warships having the metal case (released from the equipment, besides the navigation means) can be used. Such ships go the course to Antarctica with sea water ballast, there the case is filled with ice, and then come back and established on the predetermined place on the river or in northern part of a Mexico gulf (aground, on an anchor if depth allows, or drifting). The metal hull of such ship is a good conductor and in process of thawing an ice cools surrounding water. During ice transportation the case can be covered by a demountable warmly isolating covering which after the arrival on a place is removed. FIG. 10E represents some embodiments of devices for rise deep cold water described above.

FIGS. 11A and 11B show the cylinder 1102, the upper end of which is closed, the lower is opened 1163 and water mass takes place under the piston 1111, floating on water surface, and is an oscillating column. By choppy sea the dropping piston 1111 closes valve 1122 that closes the outlet 1162, and opens the inlet valve 1121 and the surface layer of water is sucked inside through inlet 1161. When piston 1111 lifts then it closes the valve 1121, opens the valve 1122 and pushes water through the output 1162 outside. Said outlet 1162 may be connected to input 1163 of a sprayer 1160 having a nozzle 1163 (in this case said cylinder 1102 must have heat isolated walls, or to right part of a skimmer FIG. 11F. The FIG. 11C illustrates second variant, wherein said cylinder includes two parts: 1103 and 1104 connected through reservoir, the inlet 1161 and 1162 are opened always, and the valve 1152 can control these devices. The lower part of said reservoir may be made flexible.

Oil film created by many oil towers, promotes Gulf water heating, reducing evaporation. FIG. 11F illustrates a method of cleaning the water surface by the example of said device. For simplicity, both parts of the device (1) and (2) are separated from each other and conditionally connected by crosspieces 1140. The left part consists of a float 1101 and a cylinder 1102 that is fixed to said float from below. The piston 1111 is located inside of said cylinder. The filter 1131 (1) is located from above. At least one pair of said filters 1131 (1) and 1131 (2) is located symmetrically in a turning disk-holder (FIG. 11E). The disk-holder is shown in FIG. 10E. Accordingly, the part (2) includes a float of 1105, and a cylinder 1106 that is fixed to said float from below. Inside said cylinder 1106 are located a floating piston 1112. The float 1105 includes a narrow part of the main cylinder 1106, inside of this narrow part of cylinder the piston 1113, connected to the piston 1112, can move. At rise of the device the pressure to piston from below weakens, and it falls. Thus valves 1121 and 1126 open, and surface water flow enters to the float 1101 (accordingly air through the valve 1126 is drawn in a top chamber of the float 1105). Then the disk-holder, on which filters are fixed, is located so, that between positions of filters 1131 (1) and 1131 (2) two empty positions (FIG. 11E) are located. At lowering this device in a hollow between waves, the holder turns said filters 1131 (1) and 1131 (2), and they are established as shown in FIG. 11F. Further, the pressure, acting to said pistons increases, and the valves 1121 and 1126 are closed, and a top water layer, which are being inside of a float 1101, is pressed through the filter 1121 in ocean, leaving on the filter surface thin oil film. At same time pressure of the piston 1112 that is transferred through the piston 1113 raises pressure in the top chamber, closes the valve 1126 and through the pipeline 1141 squeezes out said oil film from an underside of said filter 1131(2) which on it has accumulated (the waste). These wastes are gathered in the separate container or in common pipeline (are not shown). The separate mechanism for turn of said disk-holder is not shown. The areas 1151(1) and 1151(2) play role of close valves. One or several chains of similar skimmers can essentially clear a gulf surface and facilitate a temperature mode of a surface.

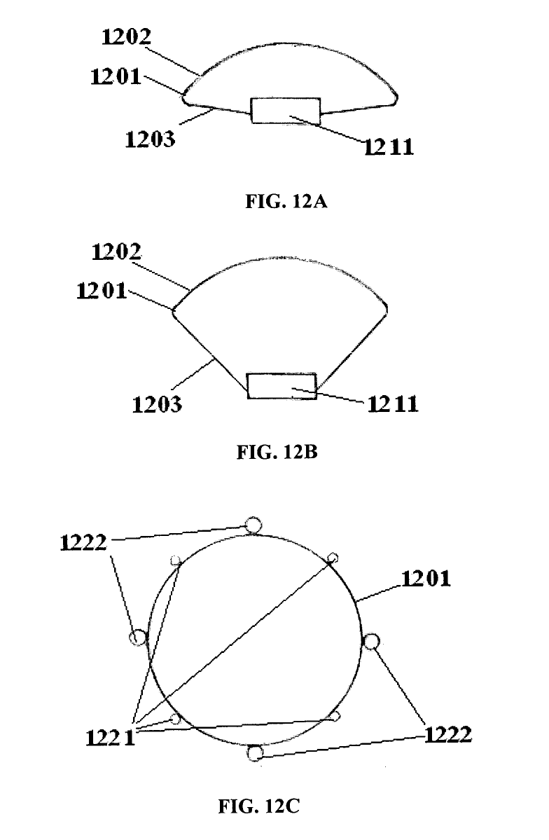

FIG. 12 shows a dirigible that is capable very fast airdropping freight. The main circular frame 1201 is a skeleton of said dirigible. The upper part of a dirigible envelop (flexible or rigid) 1202 is fastened to this frame 1201. The lower part of 1203 is made of flexible light extensible able material (elastomeric material). These modern materials allow the extension to 7 times. A unit 1211 is intended to a freight fastening and is attached from below and symmetrically to the bottom part of the envelop 1203. FIG. 12A shows the vertical cross section of an unloaded dirigible. FIG. 12B shows the vertical cross-section of said dirigible in the loaded condition. Interior of the airship is filled with light gas, and gas pressure in the loaded state of the airship should be a bit more atmospheric. Propulsion system is fixed on the main frame 1201 (not shown). On the edge of said main frame position sensors 1221 are fixed symmetrically evenly position sensors, including for example, the three-coordinated accelerometers and/or altimeters. Three or more small jet engines 1222 are fastened to said frame symmetrically evenly so that their nozzles are directed upward. At sharp airdropping of the freight (entirely or in parts) the said means (position sensors define the height of each of sensors) control said correcting jet engines. It allows compensating sharp change of elevating force of the dirigible. Similar means is necessary not only for operative delivery of means of struggle against hurricane, but also for dump of water at struggle against fires, etc.

One skilled in the art will recognize that the herein described components (e.g., steps, stages) methods, means, devices, and objects and the discussion accompanying them are used as examples for the sake of conceptual clarity and that various configuration modifications are within the skill of those in the art. Consequently, as used herein, the specific exemplars set forth and the accompanying discussion are intended to be representative of their more general classes. In general, use of any specific exemplar herein is also intended to be representative of its class, and the non-inclusion of such specific components (e.g., steps, stages) methods, means, devices, and objects herein should not be taken as indicating that limitation is desired. It is obvious, that said stages and steps of hurricane weakening can include and other influences, especially such that allow to gain a cumulative and even synergetic effect.

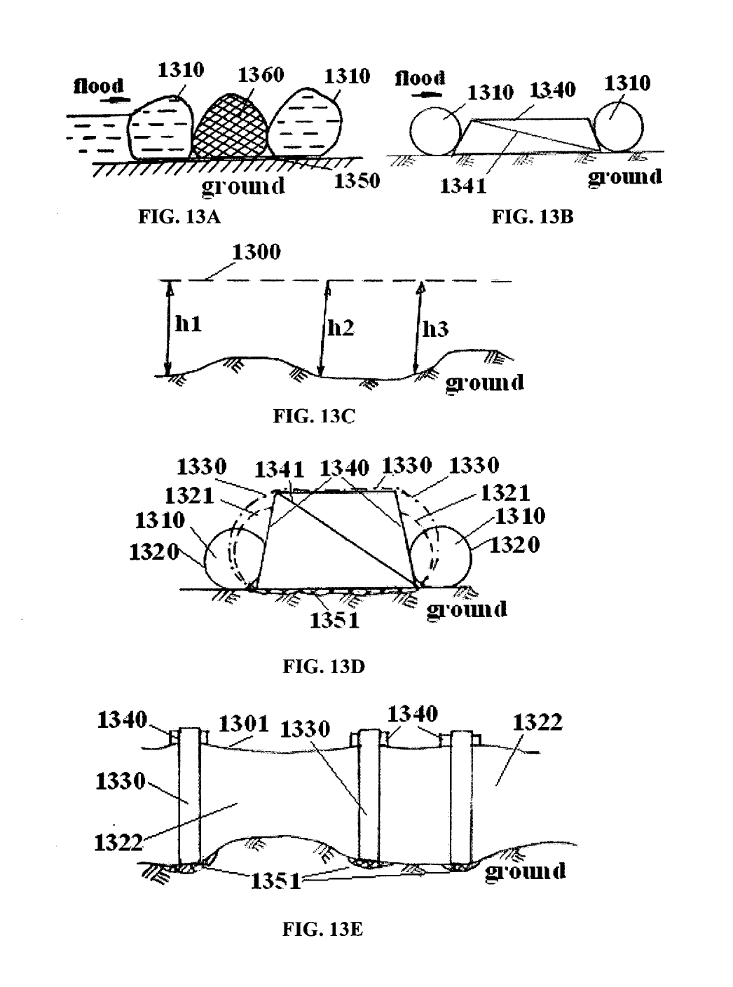

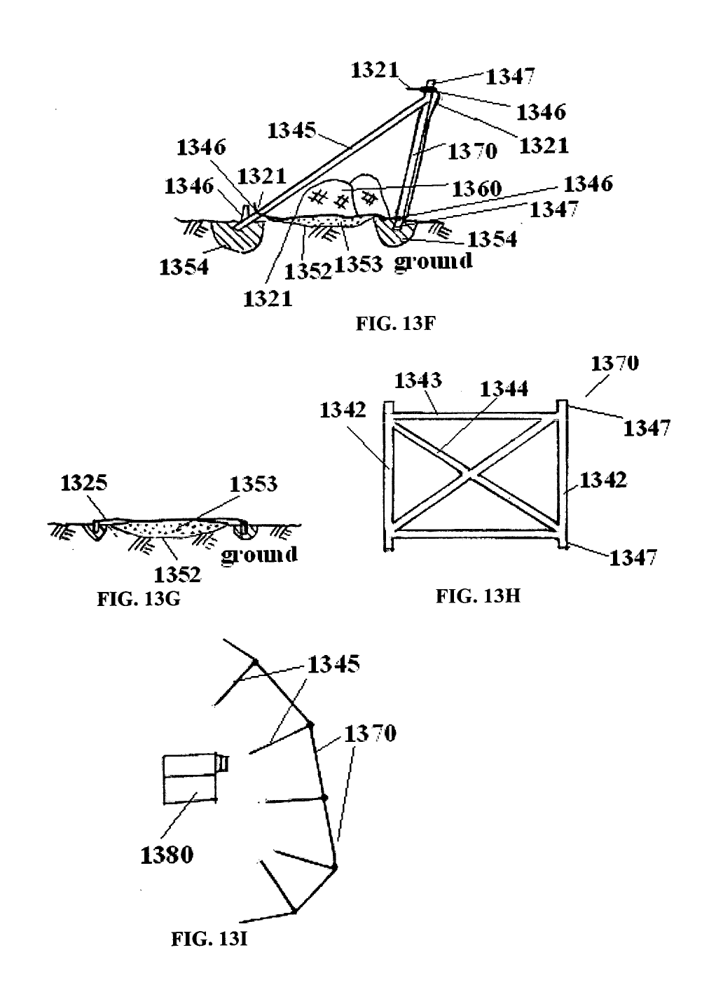

Feldman B. et al in RU Pat. 2093638 (FIG. 13A) and in U.S. pat. appl Ser. No. 12/316,249 (FIG. 13B) offered anti-flooding barrier in the form of two flexible impermeable sleeves 1310 filled with filler that is chosen from followings: water, sand, pulp, but not limiting, and connected to each other by flexible impermeable web 1350. The freight 1360 is placed between these sleeves 1310 (sand, sand bags, stones, concrete, pulp, metal etc.). This freight helps creates stability of said barrier, the forward sleeve serves as a dam on the way of flooding, and back sleeve is the back wall. Between sleeves can be located distance pieces 1340, made, for example, from metal (composite) rods or tubes in the form of harmonious designs. The strengthening element 1341 is shown.

A profile of given area (FIG. 13C) is characterized by a sequence {h(xᵢ)} defined in the points xᵢ, that are chosen so that better to approximate this function h(xᵢ) whenever possible. The distance pieces 1340 are established in these points (in hollows) between these sleeves (FIG. 13E). Said barrier comprises a plurality of belts 1330 that are built-in or fastened to said web and/or said sleeves and are capable to surround said barrier in a perpendicular direction. FIG. 13D shows, how at a tension of belts 1330 presses said sleeves 1310 to said distance pieces 1340 and their envelops 1320 take up new positions 1321, increasing height of said barrier in these places. Corresponding top crest of sleeves lifts, leveling the top crest 1301 of said barriers (FIG. 13E), forming higher dam 1322. The degree of rise of separate points of the crest 1301 is defined or preliminary, or by means of geodetic devices.

FIG. 13F-13I illustrate a barrier on the base of collapsible construction equipment for the protection of detached building 1380 against flooding. This barrier comprises a front panel 1370 (FIG. 13H), comprising beams 1342, 1343, 1344 and supported beams 1345. Said beams can be chosen from rods, tube, special profiles etc. The lateral beams 1342 having top and lower ledges 1347. This area is known, it is possible to mark and strengthen apertures (sockets) for mounting 1354. These 1354 can be made from concrete. The height of this barrier on the base of the analysis of area and forecasting can be defined (FIG. 13F). It allows choosing these panels and beams, defining a quantity of beams, their diameter and thickness. At danger said web 1321 is laid out so that cringles 1346 would be settled against 1354. The front panels are mounted so that bottom ledges 1347 pass through said cringles 1346 and were fixed in 1354. Further, mounting said beams 1345 and fixing web 1321 by means of demountable top edges. The pressure of weight 1360, the resilient band 1325, or lower covering by hydrophobic waterproof material allows reducing the water infiltration from below said web can. It may be used a sleeve 1352 that is filled with water under pressure. This pressure may create a tank filled with water, connected to this sleeve and lifted above.

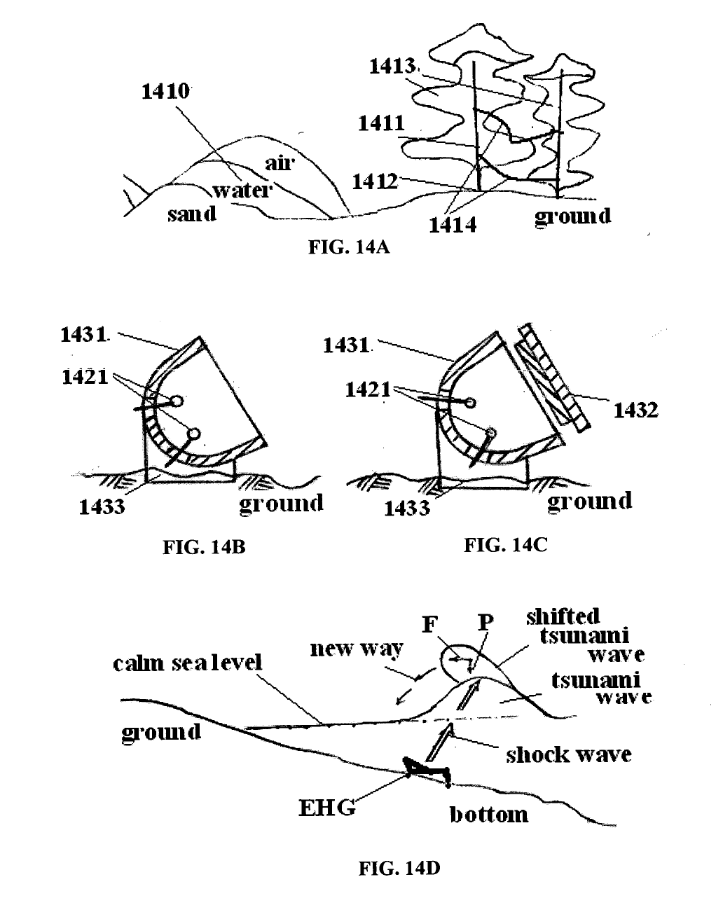

FIG. 14 illustrates passive (14A) and active means (14B-D) for protection against tsunami, according to said U.S. pat. appl Ser. No. 12/316,249. Passive means can include barriers 1410 having variable density and that force said tsunami to change its direction and to lose energy, or artificial trees 1411 having the strong foundation 1412 and plastic (composite) crone 1413. These trees are established on coast on the possible way of tsunami, their crones can have chambers, filled with water or sand, and the neighboring trees (them to make easier and more quickly than to grow up) can be connected among themselves by cables, bands or cloths (webs) 1414, keeping a decorative kind.

Further are shown EHGs (active means) and a spark gap between two electrodes 1421, the spark striking between them is capable to create a powerful shock wave. This gap is located inside concrete reflector 1431 fastened to foundation 1433. Said reflector can be opened (FIG. 14B) or is closed by a heavy cover 1432 (FIG. 14C). A plurality of such generators (EHG) are established on are possible ways of tsunami or surge waves. FIG. 14D illustrates an action of said shock wave. Directly this wave cannot weaken tsunami, but it is capable to push out water mass in air, impacting at necessary moment. If at this moment the tsunami wave extends in this mass then the tsunami wave cause said mass (or a part of it) to move air and to loss its energy in this process. Of course, it is desirable to choose this place where said tsunami wave sharply rises upwards in accordance with the bottom profile and forms a hump. Supply said EHG by energy can be executed is centralized through cables buried under bottom ground and passing through said foundations.

It will be understood by those within the art that, in general, terms used herein, and especially in the appended claims (e.g., bodies of the appended claims) are generally intended as “open” terms (e.g., the term “comprising” should be interpreted as “including but not limited to,” the term “comprises” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

I claim:

1. An improved method of dangerous phenomena (mainly hurricane and global warming) weakening, comprising one or more actions that are chosen from following stages:
a) creating global and/or regional darkening screen independently of concrete hurricane and comprising following stages:
a1)—preliminary determining places and height of one or more guiding towers for ejecting and following throwing into the air the ejected objects, chosen from followings: aerosol, small ice particles, small transforming particles, small particles optical properties of which are transformed, snowflakes, small uncontrolled soaring gliders or aircrafts from thin reflecting plastic, controlled and/or uncontrolled inflated balloons, soap bubbles, controlled or uncontrolled artificial or natural insects (further “objects”), said objects capable to keep in air and to form one or more darkening screens in Polar Jets and/or other constant polar wind flows, and capable to use also wind flows carried smog from the North continents to polar zone,
mounting said towers on said places, chosen from followings: on the ground, on sea platforms, ice surface, sea ships and so that said towers would be able to eject said objects to said wind flows,
long ejecting (at least during to sufficient time period) said objects through said towers said objects, but such that they at least do not increase a degree of a radiation absorption in case of their falling on ground, sea, ice or snow, and
creating darkening screens;
a2)—preliminary definition of places and height of said towers for ejecting of said objects, capable to create darkening screens above ocean zones of hurricane progress, using Subtropical Jets, Passat (Trade Winds) and other constant wind flows,
mounting said towers on said places, chosen from followings: on the ground, on sea platform, and so that said structures are capable to direct said objects to said wind flows,
long ejecting (at least during to sufficient time period) said objects through said towers, and creating darkening screens;
a3)—creating a plurality of sun reflecting screens from small water drops located under turbulence layer of clouds by ejecting these drops via of light-weight tube placed on autonomous moving sea vessels using only alternative energy sources for their moving and said drops generating;
b) local (in nonpolar area) actions in period of hurricane activity, comprising:
b1)—monitoring an electrical (lighting) activity in the area of hurricane forming according to measuring an electric field strength and lightings rate by one or more means, chosen from followings:
launching of rockets filled with fuel-air-explosives (FAE), rockets filled with a plurality of microwave generators, and rockets filled with metallic bands to said area of high electrical activity,
irradiating said area by laser rays and/or electromagnetic pulses;
b2)—monitoring said hurricanes and defining dangerous hurricanes (forecasting their force and direction) that require actions, and in the case if said hurricane is dangerous then:
weakening said hurricane by sowing of dust into the vortical area and along surrounding eye walls;
b3)—monitoring a condition of dangerous hurricane, including water vapor concentration, and in case if this concentration exceeds predetermined limit then sowing into the vortical area over and along surrounding eye walls with the reagents chosen from the followings: silver iodine, hydroscopic gel, dust, soot, dry ice”, and if said hurricane continues unabated, then additionally:
b4)—attacking above-water eye walls of said dangerous hurricane at same time by an explosions FAE rocket stream for hurricane structure destroying, creating through passage between internal part (eye zone) of hurricane having a low pressure and outer atmosphere and weakening electrical field in said walls,
b5)—attacking said hurricane structure by supersonic shock waves creating by:
supersonic jet aircrafts flying around said hurricane in the direction of anti hurricane rotation,
supersonic jet aircrafts secant said hurricane from above and so that said jets get over supersonic boom over the hurricane eye, and such actions are executed after FAE rocket attack or parallel it,
b6)—destroying an underwater part of said hurricane structure by a plurality of electro-hydraulic generators (EHG) fastened to knots of one ore more connecting net that are airdropped at predetermined position on the hurricane way and/or under hurricane structure at predetermined depth, and such actions are executed after FAE rocket attack or parallel it,
b7)—after or concurrently operative delivery of means for creating barriers of ascending hot air flows allowing to weaken or to deflect hurricane, comprising: airdropping jet engines and supporting means, creating ascending hot air flows on the way of said hurricane, and thus, to reject or to weaken said hurricane,
b8)—before, after or concurrently operative delivery of means for creation of cold water ascending flows by upwelling wave-pump stations and/or floating wave-pump sprayers, delivered by airdropping, by water ships or by own means, and creating barriers allowing to weaken or to deflect hurricane on the way of said hurricane, and thus, to reject or to weaken said hurricane;
c) actions, protecting against hurricane exposure and comprising:
c1)—preliminary creating means for flood protection of areas and detached buildings,
c2)—preliminary creating passive antitsunami barriers in the form of bendable plastic (composite) artificial trees filled with water and/or sand,
c3)—preliminary creating active antitsunami barriers in the form of EHGs located in places of the sharpest lifting of a coastal bottom and that are capable at the moment of passage of a tsunami shock wave to throw out in air huge mass of this water,
c4)—in the case if a sea surface about the protected sea coast already has covered with oil film, cleaning water surface from oil and surface-active means by a plurality of skimmers located in one or more lines on a surface of the sea,
c5)—preliminary cooling a dangerous gulf surface by one or more ways, chosen from followings:
lifting of deep cold water by means of upwelling water-pumps (wave-driven),
passing surface water through heat exchangers and cooling surface water,
lowering surface water in depth,
evaporating surface water, taking energy out of it, with help of by sprayers,
with the help of thawing prepared ice files, placed in said coastal zone, and in case there is a river flowing towards said zone, they are placed in a mouth and bottom current of said river also,
c6)—creating at danger a cooling water flow with the help of thawing prepared ice stocks, including stocks of “a dry ice>>, and/or other coolant (liquid N₂ etc), placed in the mouth and in the bottom current of river;
said method, wherein places and heights of said towers are chosen with regards to existing wind flows and such sea water currents, which bring the heat in direction of dangerous zone,
said method, wherein said towers can be mounted in one or several rows on the way of the chosen wind flows,
said method, comprising further monitoring atmosphere parameters on the hurricane that moves to direction of dangerous region and calculated hurricane way that allows to define time and places of said actions;
said method, wherein each of said local actions can be repeat necessary quantity times independently or in any combinations;
said method, wherein above-mentioned actions b4-b5-b6 are coordinated, and they can be carried out at the same time, or by turns;
said method, wherein choice and using one of said actions or any their combinations are depended on the real technical, economic, political and legal possibilities, testing results and the predicted hurricane way;
said method that is characterized in that said delivery means are capable to delivery said means and to leave the dangerous area at appropriate time, chosen from followings: aircrafts, dirigibles, ekranoplanes;
said method, wherein combinations of said actions are capable to suppress development of hurricane by the way of stage-by-stage its weakening and to weaken global warming.

2. The method according to claim 1, wherein said objects for creating darkening screens, are chosen from following:
long-living objects that are characterized in that a most part of them is capable to be to remain in the air flow and to keep their darkening properties during to one or more days,
long-living objects that are characterized in that a most part of them is capable to be to remain in the air flow and to change their darkening properties under external actions but so that they can restore these properties at any time after,
short-living objects that are characterized in that a most part of them is capable to be to remain in the air flow and/or to keep their darkening properties during to predetermined time at the expense of own properties or external influences, controlled and/or uncontrolled inflated balloons,
transforming objects that are capable to transform accepted radiation of one UV spectral range to IR and/or visible spectrum range;
said method, wherein said long-living objects are chosen from followings: aerosols, small ice particles or snowflakes, small transforming spectral range particles, small reflecting inflated balloons;
said method, wherein said short-living objects are chosen from followings: aerosol, small particles with transformed optical properties, small unmanned soaring gliders or aircrafts from thin reflecting plastic, small reflecting inflated balloons, soap bubbles, frozen soap bubbles, small controlled or uncontrolled artificial or natural insects;
said method, wherein said screen on the base of transforming objects may be used to compensate overheating of ground surface and to protect against UV radiation;
said method, wherein said objects can include magnetochromatic particles, that are capable to change their diffractive color under magnetic field influence;
said method, wherein said external influences can be chosen from laser or electromagnetic radiations;
said method, wherein said filler for filling said balloons and bubbles is chosen from following: natural gas, hydrogen, air or one of them combinations.

3. The method according to claim 2, wherein for changing the lifetime of said objects can be used followings:
destroying or size reducing smallest aerosol particles, said balloons and bubbles by ground laser,
changing optical properties of material-chameleon covering said objects by ground laser and/or electromagnetic generator,
controlling movement, existence and optical properties of said controlled balloons, gliders, aircrafts and/or insects by ground radio or laser generator;
said method, wherein said for controlling said life time of said balloons and bubbles can be used corresponding combinations of their envelope perviousness and molecular size of said filler

4. The method according to claim 1, wherein each of said towers comprises a through internal vertical gas-tight channel for ejecting said objects, and this tower is fastened to foundation,
said tower has one or more top outlets open to atmosphere, located at one or more predetermined heights, and its bottom inlet is connected to source of said objects,
and said tower is made in the form of one of followings:
a plurality of toruses made from flexible thin film plastic (composite), filled with air or light gas under pressure, that is more than surrounding atmospheric along all tower, and said toruses are connected so that they form a stockpile
a plurality of toruses made from flexible thin film plastic (composite), wherein at least a part of they are filled with solid aerogel, the porus of which are filled with air or light gas and connected with each other in the form of a stockpile,
a solid vertical pipe made from plastic (composite);
said tower, comprising said toruses, is characterized in that:
said toruses are located concentrically regarding the general axis,
said toruses are connected with each other with the help of connected means, chosen from: bands, glue, welding or gecko connections.

5. The method according to claim 4, wherein said towers ar characterized in that following uncontrolled means are chosen to enhance its stability:
sectioning said flexible tower on height and gyro-stabilization everyone section,
the design of tower, wherein said pipe is extended from top to bottom,
the design in which said toruses are filled with light gas so that substantially to compensate the weight of said tower and to make possible maintenance of said tower in vertical position by dirigible-like means or without these means;
combining of several towers, connected among themselves, into mutual-supporting design;
combining of central solid tower and surrounding toruses that are densely pressed and fastened with each other;
said method is characterized in that each tower, including supporting dirigible-like means, comprises also laser means for controlling its vertical position, and said laser means are connected to said laser means for correction of its direction and draft.

6. The method according to claim 4, wherein for reducing of aerodynamic resistance and enhancing its stability of said tower made from solid or flexible material said tower comprises additional group of gas-tight sections that are formed of flexible easily extensible thin strips and are fastened horizontally their top and bottom edges to external surface of said tower so that these sections filled with air or light gas cover at least a part of said tower surface, and are characterized in that:
at a calm wind they take the torus-like form, and under wind action they are extended in a lee side and take the drop-like form.

7. The method according to claim 6, wherein for reducing of aerodynamic resistance and enhancing its stability of said tower at least a part (lateral part) of said envelope of said sections is covered on the inside by piezo film divided into segments-elements in intervals so that each said element has two-dimensional address on surface and is connected to corresponding output of multiplexer, said multiplexor is connected to a control block controlling at least one of adjacent sections and including several wind speed sensors placed between each pair or said sections and located around said tower;
said method is characterized in that said block is capable to supply an electrical voltage to said elements the sequence of their addressing takes into account the indication of said wind sensors and in turn so that to organize two “travelling wave” in the necessary places of the envelope of own section to provide more early separation of the turbulent flow from the envelope;
said control block, multiplexer and sensor and their energy source (wind generator, sun cells, piezo cells) can be placed between adjacent section.

8. The method according to claim 4, wherein in the case if said tower is made in the form of stockpile of said toruses and so that each of horizontal rows comprises two or more concentrically located toruses densely attached to each other, and each of such row is located one above the other, then each quadruple of attached toruses comprises:
an additional torus, or
a group of balls having flexible gas-tight envelops, that are located between each of said quadruple and so that said additional torus and said balls are filled with air or light gas under pressure, that is a little bit greater than said torus pressure, and diameters D of said ball cross-section satisfy the inequalities d*(√2−1)<D<d, where: d—the diameter of the torus vertical cross-section;
said structure, wherein each quadruple of attached toruses can be tied together by plastic (composite) bands or are covered by glue, gecko covering or fixed by welding.

9. The method according to claim 4, wherein the ejecting of said objects by said ascending air flow that is passed inside said through channel and is produced by a pump connected to its bottom inlet, comprises:
1) in the case using said ice or snowflakes particles:
sucking in air from surrounding atmosphere through input tube of said pump, and said inlet of said input tube is located at the predetermined height in the area of negative temperature or from external cooler,
creating ascending air flow,
spraying water into said ascending flow by snow (ice) making devices, placed on the ground,
freezing said water,
lifting up said snowflakes or ice particles together with said ascending air flow, and
throwing said particles into atmosphere through top outlet of said channel;
2) in the case using other objects:
sucking in air from surrounding atmosphere through input tube of said pump,
creating ascending air flow,
mixing said objects which are fed from without with the air flow,
lifting up said objects together with said ascending air flow, and
throwing said objects into atmosphere through top outlet of said channel;
said method, wherein:
the height of said tower corresponds to he height of chosen wind flow or a little below (in the case of use of vortex-forming or accelerating equipment), and
said pump is capable to create such pressure that it exceeds surrounding atmospheric in the area of top outlet of said tower.

10. The method according to claim 4, wherein lifting up and throwing said inflatable objects (balloons or bubbles) into the air comprises following steps:
filling envelopes of said inflatable objects with light gas chosen from followings: hydrogen, natural gas, or their mix with air, through a special device having a plurality of nozzle connected to source of said filler,
releasing said filled envelopes and lifting up said balloons or bubbles under action of the elevating force;
said method, wherein said balloons envelopes are fed from special balloon device, or said bubbles are formed from soap solution that is fed from special soap device;
said method, wherein conditions of forming said bubbles are chosen from followings:
forming in the bottom of the tower at natural surrounding temperature,
forming in the bottom of the tower at negative temperature of air that is sucked by a pump through additional tube, an inlet of which is located at the height in the area of negative temperature or from external cooler,
forming said bubbles by special soap device located at the predetermined height in the area of negative temperature, on which the soap solution is lifted by means of multisectional elevator, wherein each its section includes a vertical tube, the store of said solution and the a pump, and each pump through said tube pumps over said solution from the previous store to the following store, and each store is connected to atmosphere;
said method characterized in that in the case when said objects are capable to fly using their lifting force (balloons filled with warm air or light gas, soup bubbles filled with light gas, some insects), said tower intended to form a protective barrier against wind for these objects at the initial stage of their flight comprises insulated from below from the outer atmosphere, or includes a window at the lower part that allows the wind flow in the area of the outlet of said tower to create an ascending flow helping in said lifting.

11. The method according to claim 4, wherein said tower comprise special units that are capable to equally electrify said objects that they said objects would be electrically charged and to promote deconcentration of said objects inside wind flows,
said method, wherein said units can be made in the form of discharged gap spark and can use solar cells, a wind generator and/or voltage multiplier as energy source.

12. The method according to claim 4, wherein a part of said towers comprise a set of electrical generators, a set of solid cylinders that are made from light material and fastened to said pipe; said generators are fastened to said cylinders;
said towers are characterized in that said generators are chosen from followings:
vertical-axis wind power generators that are mounted on said cylinder, comprising stators wire-coils that are located on the external surface of said cylinder around said tower and rotors that are made in the form of constant magnets, and said generators are capable to turn around said tower, using permanent magnetic levitation,
horizontal-axis wind power generators are mounted on horizontal axes that are placed approximately perpendicularly to said tower;
said tower, wherein necessary electric cables can be located inside said through channel.

13. The method according to claim 1, wherein for creating clouds from sea water drops it is used a plurality of autonomous vessels, each of which uses wind energy and comprises:
navigation means, including: GPS, control unit and a sail mounted on the top of said vessel and controlled by said control unit connected to GPS,
a pipe extended upwards, having a internal through channel and mounted on the vessel deck from leeward side ahead of the sail,
a generator of sea water drops,
a wave energy converter (WEC) fastened to said vessel astern by connecting cables and capable to produce electrical energy when moving vessel,
said vessel, wherein said pipe has two states: working state and folded state, and wherein:
said navigation means are capable to transform said sail from working state to folded state in the case if wind becomes stronger than predetermined limit, and to return back otherwise,
said drop generator is fixed under the lower inlet of said pipe and is capable to generate a flow of water drops having necessary size, using piezo, ultrasound or mechanical drop-forming device, and is connected to the control unit,
said control unit is connected said WEC, the sail and is capable to control said sail;
said vessel, wherein said WEC can be made in the form of a elongate flexible water-tight snake-pipe closed from both ends, filled with water, includes an electrical generator (EG) placed on its forward end and is capable to produce electrical energy under bending in the moving,
said vessel, wherein further:
said elongate flexible water-tight pipe can float at predetermined depth,
said EG is connected to said navigation means and said drop generator by said cable.

14. The method according to claim 1, wherein destroying said underwater hurricane part comprises following steps:
connecting a plurality of EHGs in the form of a net, where each of said EHGs is connected to one knot of the net, said net including a plurality of floats fastened to top part of said net, a plurality of plummets fastened to bottom part of said net and at least two autonomous towboats connected to two opposite lateral top knots,
folding said net and loading this folded net in cargo aircraft,
deliver said net to the predetermined place that is on the way of hurricane,
airdropping said net and unfolding said net using said towboats,
generating electro-hydraulic shock wave after initiating signal about hurricane;
said method, wherein each of said EHGs comprises a charged super capacitor, as energy source that is charged preliminary, and discharged crosspiece (band or wire) or discharged gap;
said method, wherein each of said EHGs is electrically connected to common circuit that is connected to one or more explosive initiator, and said initiator is chosen from followings: impart sensor, timer, acoustic, radio or laser sensor.

15. The method according to claim 1, wherein said hot air flow is created by jet engines, comprises following steps:
preparing a group of boats and mounting jets on said boats,
preparing a group of pontoons and filling their fuel banks with fuel,
delivering said boats and pontoons with the help of said delivery means in predetermined place on hurricane way,
airdropping said boats and pontoons, and after dropping said boats and said pontoons under the automatic control carried out followings:
finding said pontoons to each other, approaching and mooring with each other in the form of common pontoon,
finding said boats corresponding mooring places belonging said common pontoon,
approaching said boats to corresponding mooring places of said common pontoon and mooring said boats to said common pontoon,
assembling fuel system of these pontoon and boats and forming the common fuel distribution system,
switching on said jet engines so that their nozzles were directed upwards,
initiating signal about approach of hurricane and creating hot air ascending flow by working jet engines;
said method is characterized in that each of said boats and pontoons comprises navigation means (GPS, propulsion system, and recognition means) and is chosen so that said delivery means would be able to deliver them on time.

16. The method according to claim 1, wherein for cooling water surface it uses “roving” vessels, and which is characterized in that each of said vessels includes:
at least one U-shaped conduit extending downward from said vessel, said conduit has an descending part and ascending part, connected at the bottom to each other submerged by bridge-heat exchanger, said conduit is characterized in that the inlet of the descending part, that is fastened to a funnel located on the top vessel, and said inlet is located higher than the outlet of the ascending part, located near water surface,
a propulsion system in the form of sail(s) and control block, and power source in the form of sun cells that can be located on the top of said vessel or on the surface of said sail and its capacity (together with accumulators or supercapacitors) is capable for supplying said sail(s) and control block, controlling said sail(s) and said vessel;
said funnel that is connected to downwards conduit and is located in lower part of a scoop, and said scoop bottom has a ramp that is opened in the opposite direction of moving said vessel, and the shape of said scoop is a wave concentrator,
said funnel is located so that its edge was not higher than the height of waves created by said concentrator,
said conduit has such length to the heat exchanger can be located in a layer of sufficiently low temperature,
navigation means;
said method, comprising following steps:
moving each of said vessel in the area, having sufficient depth,
lowering said conduits and heat exchanger so that the top end of the descending conduits was fastened from below to said funnel located on the scoop bottom,
releasing said sail(s), and further by moving said vessel
the wave increases and through fore part of an inclined plane of said scoop reaches said funnel, creating pressure that pushes water through said conduits and heat exchanger and further pushing this chilled water through said outlet in surrounding ocean.

17. The method according to claim 1, comprising cleaning water surface from oil and surface-active means by a plurality of floating skimmers that are located on this surface, and said cleaning comprises three following processes that use wave-driven technology cyclically and are carried out in parallel:
the first process comprises:
at lifting said skimmer to the crest a first chamber is filled with surface water through opened inlet valve (at its closed outlet valve),
at lowering said skimmer to trough between waves the water pressure closes said inlet valve, opens said outlet valve and ejects water that is filled said chamber through said outlet valve and further through one part of working surface of a filter, and yet further in ocean;
the second process comprises correspondently:
at lifting said skimmer to the crest a second chamber is filled with air through opened its inlet valve (at its closed outlet valve),
at lowering said skimmer to trough between waves the water pressure closes said inlet valve, opens said outlet valve and ejects air that is filled said second chamber through outlet valve and further through second part of opposite surface of said filter, forcing out a mud to local container or to common pipeline,
the third process comprises correspondently:
at lifting said skimmer to the crest said filter is moved (or is turned) so that its purified part is mounted against said first chamber, and polluted part against said second chamber;
said method, wherein said processes can be incorporated.

18. The method according to claim 1, wherein said ice delivery from polar areas to area of some river mouth is carried out by the way is chosen from followings:
with the help of ground transport,
in the form of natural icebergs by means of tows or in the form of the artificial ice ships by means of built in driving modules,
in heat-insulated holds of tankers in the form of ice blocks or container ships in the form of heat-conducting containers filled with ice,
in ships, similar lighter aboard ships, transporting ice blocks or the said containers in heat-shielding lighters (barge), capable to rise upwards on the river up to predetermined places;
said method, wherein said delivered ice blocks or containers or lighters filled with ice are placed along lower current of said river and the mouth (at the bottom or on coast) so that in case of storm danger at least a part of cooling surfaces of ice mass or heat-conducting walls of containers with an ice would be or could be moved in the field of the fastest current, remaining anchored, or near to said mouth aground;
said method, wherein said icebergs or ice blocks or remaining anchored (or aground) for acceleration of thawing in the case of hurricane dangerous are broken into pieces by means of explosions of built charges.

19. The method according to claim 1, using special means for flood protection in the form of flexible barrier and wherein said barrier includes: two sleeves having flexible impermeable envelopes and connected by flexible impermeable web intended for placement of weight, a plurality of rigid distance pieces holding constant distance between said sleeves and tightening belts and said pieces and belts are placed in the same places;
said method, wherein said pieces are chosen from followings: masonry structure or on the base of collapsible construction equipment and their height is no less than expected height of flooding; and comprises following steps:
straightening and laying said barrier together with said belts on given locality,
mounting said distance pieces along said barrier at least in lower places,
filling said sleeves with filler and connecting of each pair said belts that are placed with different sides of the barrier and their such tensing that the height of thee barrier has reached said expected height to compensate roughnesses of this locality,
fastening said belts;
wherein said weight can include various materials chosen from following: sandbag, sand, stones, concrete blocks, bricks, metal equipment and/or machines, ground, pulp, soil, plastic bottles filled with sand, collapsible construction equipment.

20. The method according to claim 1, using special means for flood protection of detached building in the form of barrier comprising:
a front panel made from collapsible construction equipment, approximately rectangular form, including beams (tubes, rods, special profiles) and two extreme lateral beams have the top and lower ledges, said top ledges can be removable,
at least two supporting beams that support said front panel,
a flexible stronger impermeable web;
said method, comprising for detached building protection following steps:
preliminary surrounding area preparation, creating apertures for front panels and supporting beams mounting, choice of a complete set of collapsible structures and beams, pattern shearing said web and fastening cringles for given structures and at least two row (front and back) said apertures;
and in the case of dangerous:
leveling said web on said area to make said cringles agree with said apertures,
mounting said front panels so that said lower ledges pass through said cringles and fix to said front in said apertures,
mounting said supporting beams so to fasten them between the top part of front panels and said back apertures;
said web may include additional means for reduce of an infiltration, chosen from followings: a sleeve extended along said barrier, filled with water and placed between said web and ground or above said web and that said web and said sleeve are pressed to ground by various weights or special bands; low hydrophobic covering;
said web may be pressed to ground by various weights located from above or additional pressure that is created inside said sleeve by an external source in the form of a tank filled with water and established much above).

21. An improved FAE rocket, comprising:
a rocket housing, including a driving section and an explosive section,
said FAE rocket, wherein said explosive section comprises:
a high explosive for said housing destroying,
a detonating fuse, connected to said high explosive and a first sensor (or timer),
a folded and/or made from extendable material balloon having a gas-tight envelope, and wherein said first sensor (or timer) is turned on by launching said rocket, according to external signal or environment parameter measuring;
said FAE rocket, wherein said high explosive is capable to destroy said housing and to release said chamber from said destroying housing,
said FAE rocket, wherein said balloon is filled with oxygen-deficient fuel, and said balloon comprises:
one or more second sensors (or timer),
one or more detonators connected to said second sensors (or timer),
means that are capable to extend said balloon,
one or more through holes in the gas-tight envelope of said balloon,
said FAE rocket, wherein said extending means are chosen from followings:
closed tubes built into an envelope of said balloon, said tubes are connected with one or more containers filled with compressed gas,
closed bands made from alloys with shape memory,
an resilient plastic or a whalebone,
one or more pump sucking in air and located in said holes;
said FAE rocket, wherein said extending means are capable:
to extend said chamber so, that to suck in sufficient quantity of air for formation of the explosive mix,
said FAE rocket, wherein said second sensor (or timer) characterized in that it capable:
to detect the inflammable concentration of said mix,
to initiate the explosion of said inflammable concentration;
said second sensor (timer) is capable to detect said inflammable concentration using one of followings: given time interval, balloon size or mix concentration.

22. An improved delivery means for operative delivery of the equipment, combustible, reagents or water, comprising:
a rigid skeletal frame having a round horizontal cross-section,
a smooth, gas-tight envelope, consisting of two parts: top inextensible and bottom extensible parts, said envelope is filled with light gas and is attached at least along edge of said skeletal frame,
a group of engines for said delivery means moving, and said engines are attached to said frame outside,
three or more additional correcting jet engines pointed downwards and fastened to said frame along its edge outside at regular intervals,
three or more means (GPS, altimeters, accelerometers) for definition of height and/or position change and fastened to said frame along its edge outside at regular intervals,
a control device, connecting said means for definition of height and/or position change and said additional engines,
means of fastenings a weight to said bottom part centered relatively to said frame;
said delivery means are characterized in that:
means of fastening said weight are executed so that centers of gravity of the weight and delivery means lie on one vertical line,
said bottom extensible part is executed from elastomer or in the corrugation form, and the size of said bottom part expansion is sufficient to compensate weight of transferable weight,
efforts developed by said additional jet engines are capable to compensate variations of the lifting force and to hold the horizontal position of said delivery means by said weight dumping in the predetermined limits.
